(19) United States
(12) Patent Application Publication
(10) Pub. No.: US 2004/0168052 A1
(43) Pub. Date: Aug. 26, 2004

(54) Electronic content communication system and method

(76) Inventors: Allister B. Clisham, San Diego, CA (US); Han T. Lam, San Diego, CA (US); Balaji Lakshmanan, San Diego, CA (US); Dexiang Edward Luo, San Diego, CA (US); Praveen Kumar, San Diego, CA (US); Mehran Erfani, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/375,508

(22) Filed: Feb. 25, 2003

(51) Int. Cl. H04L 9/00

(52) U.S. Cl. 713/153

(57) ABSTRACT

A content file communication system and method interconnects a client device with a content server using a wireless high-speed communication link. The client device connects to the content server and a user is able to view one or more content files stored in the content server. The user can select one of the content files for download. Each content file can be stored in the content server as multiple segments. Each segment can include a header portion and a body portion. The header portion can be encrypted and the body portion can be encoded. The content server transmits the selected content file over the high-speed communication link to the client device. At least a portion of the content file is transmitted at a rate higher than a presentation rate. At least a portion of the content file received by the client device is cached, then presented to an output.

### BACKGROUND OF THE INVENTION

1. Field of the Invention

The invention relates to electronic communications. More particularly, the invention relates to content on demand.

2. Description of the Related Art

The continued increase in processing power incorporated into integrated circuits, such as processors, digital signal processors, compressor/decompressors (CODECs), Application Specific Integrated Circuits (ASICs), and the like has allowed electronic devices to perform exceedingly computation intensive tasks. Additionally, and as a by product of increased processing power, electronic devices are commonly linked together with communication links, such as point to point links, wired links, wireless links, networks, and the like. Examples of wired links include, but are not limited to, twisted pair, coaxial, and serial or parallel bus connections. Examples of communication networks include, but are not limited to, local area networks, wireless telephone networks, and the Internet.

However, devices may be unable to effectively utilize the advantages of increased processing power when information is transmitted over communication links because of bandwidth limitations of the communication links. Digital processing techniques implemented to compensate for the limited communication bandwidth and associated content delivery protocols can heavily load the processors, thereby negating much, or all, of the advance in processing power.

For example, many consumer devices are configured to access the Internet and can receive content from servers connected to the Internet. Presently, the amount of bandwidth available to a typical consumer is limited. A typical consumer computer connected to the Internet with what is presently considered a broadband connection may only be able to download content at a rate less than about 2 Mbps. Typically, the actual download rate experienced by the consumer user is significantly less than 2 Mbps. The actual download rate experienced by the user is affected by such things as upload limitations at the source and loading experienced by the communications network connecting the source to the client device.

Even at 2 Mbps download rate is insufficient for communicating some types of content. For example, high quality video content requires in excess of 6 Mbps. Many communication systems compensate for insufficient bandwidth by compressing the content. The content can be encoded in order to reduce the size of a content file and allow delivery of the file in less time, or at a lower data rate, than is required for delivery of a corresponding non-encoded file. However, an encoded high quality digital video file may require approximately 4-6 Mbps data rate transmission, which is still much greater than the bandwidth available in a typical consumer broadband device.

Lossy compression techniques are available to further decrease the size of a content file, but by the very definition, the lossy compression techniques lose some of the content information and sacrifice some level of quality. When lossy compression techniques are used to compress video files, the available picture size may be greatly diminished and there can be artifacts of the compression technique visible in the video picture when the file is decoded and presented during playback. These artifacts can include choppiness of the picture, giving it a strobed effect, or blocking or pixelization of the picture, which is seen as computerized blocks of color or dark space in the picture.

Streaming client server technologies and protocols that are available today attempt to deliver content to client devices using the available limited communication bandwidth. Compressed content is transmitted to the client device using the limited bandwidth communication link. The protocols and technology used in typical content delivery mechanisms include error control mechanisms designed to ensure the content is delivered reliably. However, the error control mechanisms typically require additional signal bandwidth from the already insufficient communication bandwidth. The error control mechanisms further load the processors at both the client device and the server. Additionally, some media players that are designed to present video content, such as movies, are constrained by a predetermined file size limitation.

What is desired is a system and method of communicating electronic content, such as media files and video, from a source to a destination without the present limitations.

### SUMMARY OF THE INVENTION

The invention encompasses systems and methods for communicating content files from a content source over a wireless network to one or more client devices. In one aspect, a content file communication system and method interconnects a client device with a content server using a wireless high-speed communication link. The client device, or alternatively user device, connects to the content server and retrieves a list of one or more content files stored in the content server. The user can select one of the content files for download. Each content file can be stored in the content server as multiple segments. Each segment can include a header portion and a body portion. The header portion can be encrypted and the body portion can be encoded. The content server transmits the selected content file over the high-speed communication link to the client device. At least a portion of the content file is transmitted at a rate higher than a presentation rate. At least a portion of the content file received by the client device is cached, then presented to an output. The client device can present a portion of the content file while additional segments are downloaded.

In another aspect, the client device decrypts the segments and stores the decrypted segments in storage that can include volatile and non-volatile memory. A data handler uses data determined as a result of decrypting the segment headers to determine a length and relative location of the segment. The data handler uses the relative location data to order the segments for presentation.

In another aspect a player component decodes the segments in the order determined by the data handler. The player component presents the decoded segments to a user via a user interface that can include a display and an audio output.

### BRIEF DESCRIPTION OF THE DRAWINGS

This and other aspects, features and advantages of the invention will be apparent upon review of the following detailed description and the accompanying drawings.

FIG. 1 is a functional block diagram showing client devices connected to a content source using a communication link.

FIG. 2 is a functional block diagram of a client device.

FIG. 3 is a functional block diagram of a data handler component within a client device.

FIG. 4 is a state diagram of a protocol component within a client device.

FIG. 5 is a simplified flow diagram of client-server interaction.

FIG. 6 is a flowchart showing a method of the content source providing a content list in response to an information request.

FIG. 7 is a flowchart showing a method of the content source providing a list of paused sessions.

FIGS. 8A-8B are flowcharts showing a method of the content source initializing a session in response to a user request.

FIGS. 9A-9B are flowcharts showing a method of the content source initializing billing as part of session initialization.

FIG. 10 is a flowchart showing a method of the content source aborting a session in response to a user command.

FIG. 11 is a flowchart showing a method of pausing an active session in response to a user command.

FIG. 12 is a flowchart showing a method of the content source resuming a session in response to a user command.

FIG. 13 is a flowchart showing a method of the content source ending an active session in response to a user command.

FIGS. 14A-14B are flowcharts showing a content on demand method implemented in a client device.

FIG. 15 is a functional block diagram of a wireless content communication system.

FIGS. 16A-16B are flowcharts of a process performed by a session monitor daemon.

### DETAILED DESCRIPTION OF THE PREFERRED EMBODIMENT

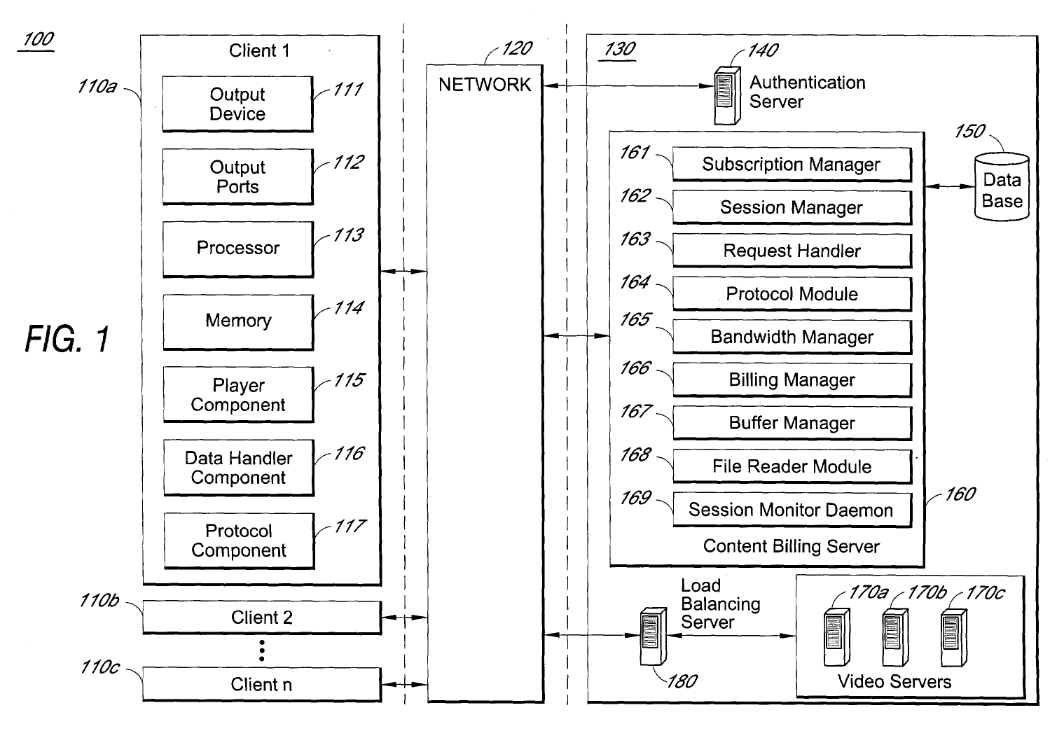

FIG. 1 is a functional block diagram showing a content communication system 100 including multiple client devices 110a-110c connected to a content source 130 using a communication link within a network 120. Each of the client devices 110a-110c can access a variety of content services after connecting with the content source 130. The client devices 110a-110c can access the content source 130 via the network 120 to access and retrieve content stored in the content source 130.

One or more client devices 110a-110c can simultaneously be connected to a network 120. The network 120 connects each of the client devices 110a-110c to a content source 130. The network 120 can include one or more communication links (not shown) that are used to connect a client device, for example 110a, to the content source 130. An example of such a network is described in U.S. patent application Ser. No. 10/211,173, filed Jul. 31, 2002, entitled “WIRELESS METROPOLITAN AREA NETWORK SYSTEM AND METHOD” hereby incorporated herein by reference in its entirety.

Each of the client devices 110a-110c can communicate with the content source 130 over one or more communication links provided in the network 120. A client device, for example 110a, can authenticate itself with the content source 130 in order to be allowed access to content stored in the content source 130. The client device 110a can then request a list of content that is available for delivery from the content source 130 to the client device 110a. The client device 110a can select a particular content file from the list received from the content source 130. The client device 110a can then transmit, to the content source 130, a request for the selection. The content source 130 can then retrieve the content file corresponding to the client device selection and transmit the file, using the communication link, to the client device 110a.

The functional block for a first client device, client device 1 110a, provides a detailed functional block diagram of one embodiment of a client device that can function as a client device in the content communication system 100. Client device 1 110a is typical of a client device and represents the typical functional blocks found within a client device 110a-110c. One or more other client devices 110b-110c can include some or all of the functional blocks incorporated within client device 1 110a. Additionally, one or more of the other client devices 110b-110c can include additional functional blocks.

The first client device 110a can include an output device 111 configured to display or otherwise present delivered content files to the user or operator. The content files can include media files, such as video, audio, or multimedia, and can also include operational or executable files that can instruct the client device 110a to perform a particular operation or function. A video file can include a video output that is presented at a predetermined rate and an associated audio output that can be synchronized to the video output. Similarly, a multimedia file can include video, audio, and other elements, such as operational or executable functions performed by the client device.

The output device 111 can perform electronic functions, such as lighting indicators or tuning a transmitter frequency, or can perform mechanical functions, such as moving levers, operating cams, or turning wheels. Of course, the output device 111 can be configured to perform a combination of electrical or mechanical functions when presenting a content file.

Although the output device 111 can present a static output, such as a single picture or a single display indication, the content communication system 100 can be optimized to present dynamic content, such as video content or multimedia content. Dynamic content can be contrasted to static content in that dynamic content changes on a predetermined basis. Typically, dynamic content varies with time, although it is not a requirement that time be the predetermined basis that triggers a change in the dynamic content. For example, video content can be considered one type of dynamic content. Video content is typically presented on an output device 111 as a picture having a refresh rate that occurs at a predetermined number of frames per second. Thus, although the picture displayed on the output device 111 can appear to be static, the video content is dynamic and updated at the refresh rate. The dynamic aspect of video content is much more evident when the picture changes across frames to provide the appearance of movement in the picture.

The client device 110a can also include one or more output ports 112 in addition to an output device 111 or integrated with the output device 111. The output ports 112 can allow a signal to be output to an external device (not shown) such as an external output device, an external storage device, a signal distribution device, a signal processor, another client device, and the like. For example, a portable client device 110a can incorporate a relatively small display and can include a video output port 112 that allows the display of a video content file onto a larger display. Alternatively, the client device 110a can omit the output ports 112 if it is preferable not to provide an output source for content received by the client device 110a.

The client device 110a can also incorporate a processor 113 and memory 114. The processor 113 can perform tasks such as the decoding of received content files. The processor 113 can also perform other signal processing tasks as well as functions relating to a user interface or relating to maintenance of the client device 110a. Received content files, as well as processor readable data or instructions, can be stored in the memory 114 for access by the processor 113. The memory 114 can be configured as one or more devices and can include volatile as well as non-volatile memory. The memory 114 can include integrated circuit memory, magnetic storage, optical storage, and the like.

The client device 110a can also include a player component 115, a data handler component 116, and a protocol component 117. These components will be discussed in greater detail below. As a brief introduction, the player component 115 is configured to interface with the output device 111 to present to the user the content represented by a received content file. For example, where the content file is a video file, the player component 117 presents to the user, via the output device 111, the video stream represented by the content file. The data handler component 116 is configured to process the content file received from the content source 130 and present it to the player component 115 as if the content file were local to the client device 110a. The protocol component 117 is configured to retrieve the content file from the network 120. As implied in its name, the protocol component 117 is configured to interface with other elements using a specific protocol implemented to communicate the content file or associated overhead information, such as commands.

The client device 110a can control the download of content files from the content source 130. The content source 130 can provide the client device 110a with a media descriptor that identifies one or more segments that correspond with a desired content file. The content source 130 can provide the media descriptor once the client device 110a purchases or otherwise is granted access to a content file. Additionally, the content source 130 can generate content files, such as advertisements or informational updates, that are pushed to the client device 110a. The content source 130 controls content that is pushed to the client devices 110a-110c.

As noted earlier, each of the client devices 110a-110c can be configured similarly, or one or more of the client devices 110a-110c can be configured with more or less functional blocks that are detailed in the first client device 110a. Each of the client devices 110-110c can be connected to a content source 130 using a network 120. One or more client devices 110a-110c can simultaneously be connected to the network 120 and one or more of the client devices 110a-110c can simultaneously be connected to the content source 130. One or more of the client devices 110a-110c can connect to the network 120 using a wired link or a wireless link. The wired link can comprise an electrical link, an optical link, a combination of electrical and optical links, and the like. The network 120 itself can be comprised of electrical links, optical links, a combination of electrical and optical links, and the like. The network 120 can comprise a number of point to point links from client devices 110a-110c to a content source 130. Alternatively, a number of client connections can be multiplexed on one or more bus lines in the network 120. The network 120 can be configured as a cross connected network, as a star network, or as a combination of cross connected and star networks. The actual configuration of the network 120 is not a limitation provided the network 120 connects the client device 1110a-110c to the content source 130 with a sufficient data bandwidth to implement at least one of the embodiments described herein.

A content source 130 is also connected to the network 120. Typically, the content source 130 is placed at a location that is remote from one or more client devices 110a-110c. The content source 130 typically includes an authentication server 140 that is configured to authenticate client devices 110a-110c attempting to connect to, or attempting to receive content from, the content source 130. A content communication system 100 that is configured to provide unrestricted access may not include an authentication server 140. Where an authentication server 140 is not included in the content source 130, the authentication steps detailed in the discussions provided below can be omitted.

The content source 130 also includes a content billing server 160 that is used to manage a communication session between a client device 110a and the content source 130. The content billing server 160 controls the client device 110a access to the content stored, for example, in the video servers 170a-170c. The content billing server 160 accesses a database 150 that can store user account information, billing rates, and other system information. The database 150 can be non-volatile memory, such as hard disk storage, Redundant Array of Independent Disk (RAID) array storage, Electronically Eraseable Programmable Read Only Memory (EEPROM), Non-Volatile Random Access Memory (NV-RAM), FLASH memory, and the like, or some other type of memory, data storage, or means for storing data.

The content billing server 160 can be a computer, such as a server, and can be multiple computers in communication with each other. The content billing server 160 includes a subscription manager 161, a session manager 162, a request handler 163, a protocol module 164, a bandwidth manager 165, a billing manager 166, a buffer manager 167, a file reader module 168, a session monitor daemon 169, and a load balancing server 180. The managers, modules, and handler included within the content source 130 can be separate computers, hardware, or can be processes (software) stored as processor readable instructions stored in memory within one or more storage devices. The processor readable instructions can be accessed and operated by one or more processor in conjunction with other hardware devices.

The subscription manager 161 controls the levels of access to content provided to a client device, for example 110a. There can be multiple levels of access within a content communication system 100. A client device 110a associated with a user account can be allowed access to one or more types of media content stored within the content source 130. For example, a client device 110a can be restricted to accessing content of only one type, such as music files, or static images. Alternatively, a client device 110a associated with a user account can be restricted to accessing only movies or stored video files. Users can pay for greater access levels within the system 100. For example a user can establish a subscription level that allows access to any type of content or media stored within the content source 130.

The session manager 162 controls actual access and delivery of a particular content file. Delivery of a particular content file can be configured as a session within the content source 130. The session manager 162 controls the delivery of the content, in part, in response to requests and commands transmitted by the client device 110a. The session manager 162 manages active client device session states and can control the state of a session for a given client device 110a.

The request handler 163 operates at the interface to the network and is responsible for accepting connections at the socket level and managing the maximum number of client device 110a-110c connections at any point in time. The protocol module 164 parses incoming data over the valid connections maintained by the request handler 163 and invokes the functions controlled by the media servers, such as video servers 170a-170c. Initial communication from the network to the media servers is received at the request handler 163 which communicates the request to the protocol module 164. The data from the protocol module 164 is transmitted over the network 120 to destinations connected to the network 120.

The bandwidth manager 165 adjusts the data rate to the client devices 110a-110c based on the number of client device sessions and available bandwidth. The bandwidth manager 165 typically allocates a bandwidth that is equal to or greater than an encoding data rate. The maximum data rate that can be allocated to a client device, for example 110a, is only limited by the maximum network bandwidth. Thus, in an extreme case, the bandwidth manager 165 can allocate the entire network bandwidth to a single session to a single client device 110a.

The billing manager 166 communicates with the session manager 162 and subscription manager 161 to determine a bill corresponding to a content session invoked by a client device 110a. For example, the bill determined by the billing manager 166 can depend on the media type retrieved from the content source 130, the length of the content file, the network loading during the session, a predetermined subscription rate, and other factors.

A buffer manager 167 controls a buffer storage for content files. The buffer manager 167 can retrieve and store in buffer memory portions of a particular content file when it is requested by a first client device, for example 110a. Then, if the same content file is requested by a second client device, for example 110b, the buffer manager 167 controls retrieval of the content file from buffer memory the content file previously retrieved for the first client device 110a. The buffer manager 167 controls a temporary buffer as a cache that can be accessed for retrieval of content recently retrieved for other client devices. The temporary buffer can be, for example, RAM or other high-speed memory. The buffer manager 167 is used in conjunction with buffer memory to server multiple sessions to multiple client devices, 110a and 110b, without requiring multiple accesses to the content file in permanent memory, such as on a hard disk. Thus, the same content file can be served to multiple client devices, 110a and 110b, without multiple disk accesses.

A file reader module 168 operates in conjunction with the buffer manager 167 to retrieve content files from memory. The file reader module operates to retrieve requested content files from memory. The memory accessed by the file reader module 168 can be secondary memory, such as hard disks, optical disks, RAID arrays, and the like.

The content files are stored in one or more servers, here shown as video servers 170a-170c. The content files can represent any type of media, for example, video files, audio files, static images, multi-media, and the like. The content files can be stored within a single video server, for example 170a, or can be stored in two or more video servers 170a-170c. The content files can be stored as multiple encoded segments. Storing the content file in an encoded format eliminates the encoding step prior to transmission to the client device, e.g. 110a. Additionally, by storing the content files as multiple segments, the segments can be transmitted out of order or simultaneously by one or more video servers 170a-170c to be reordered at the client device, e.g. 110a. The video servers 170a-170c can then be configured to load share transmission of the content files. That is, more than one of the video servers 170a-170c can store a copy of the content files. Then as a client device, for example 110a, downloads a content file, the load-balancing server 180 can determine the video server having the least loading, for example 170a, that can provide the file segment. The video server providing the content segment can be dynamically determined and changed for each downloaded media segment.

The load balancing server 180 allows the content source 130 to provide higher quality of service and efficient content delivery. The load balancing server 180 also helps to avoid single point failures. As described above, a single content file can be divided into multiple segments. The segments can be distributed across one or more of the video servers 170a-170c and copies of the same segment can be stored in more than one of the servers 170a-170c. The segments do not need to be stored in the same encoding format, but can be stored in different encoding formats supporting different bit rates. The load balancing server 180 operates to allow content files to be delivered or accessed by a client device 110a in a manner that is transparent to the client device 110a.

The load balancing server 180 resides between the video servers 170a-c and the network 120. The load balancing server 180 ensures the client device 110a is able to access the desired content file segment and allocates access to the various video servers 170a-170c in a manner to balance the loads placed on them.

The load balancing server 180 can maintain a table of data based on, for example, connections, bandwidth usage, maximum bandwidth supported by a particular server, availability of stream pumps, segmentation, content encoding rate, and content bit rate distributed over the various servers 170a-170c. The tables can be populated and updated by the video servers 170a-c or the load balancing server 180 can query each video server 170a-c for this information. The load balancing server 180 can then allocate access to the various servers 170a-c based in part on the information stored in the table.

The content billing server 160 provides the client device 110a with access to the content stored on the video servers 170a-170c. The client device 110a can then retrieve content files for local presentation. The client device 110a accesses the video servers 170a-170c via the content billing server 160 but from the client device 110a perspective, the content files are provided directly from the video servers 170a-170c through the network 120 to the client device 110a.

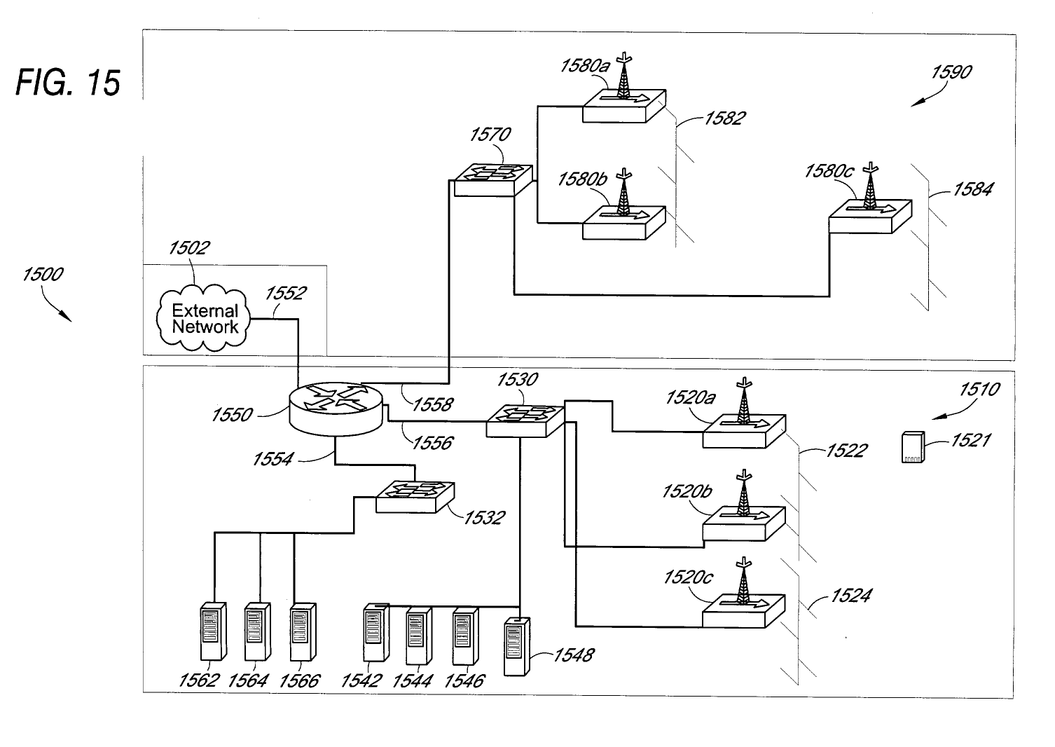

FIG. 15 is a functional block diagram of an embodiment of a metropolitan area network (MAN) 1500 configured to enable communication that can support delivery of content on demand. The MAN 1500 of FIG. 15 is an example of the network 120 and servers 140, 160, and 170a-170c shown in FIG. 1. The client device 1521 in FIG. 15 can be one of the client devices 110a-110c from FIG. 1. FIG. 15 provides a more detailed diagram of the interconnections and interfaces in the network. Although only one MAN 1500 is shown in FIG. 15, multiple MANs can communicate with one another over a high speed communication link, such as a fiber optic link using packet-over-SONET. Then, a client device 1521 can access a content source on another MAN (not shown).

The MAN 1500 is configured to provide broadband communications, and can be configured to provide communication link between client devices capable of carrying 6 Mbps. For example, a client device 1521 or a server, for example 1562, can be configured to transmit packetized streams at a rate that is approximately equal to, or greater than, about 1 Mbps, 2 Mbps, 3 Mbps, 4 Mbps, 5 Mbps, or 6 Mbps. The client device 1521 can receive the packetized transmit streams across the wireless link of the network. The client device 1521 can be configured, for example, to implement IEEE 802.11 a wireless communication to the network at a rate of up to 6 Mbps.

The MAN 1500 includes a first sub-network 1510 and a second sub-network 1590 connected to a single router 1550. The sub-networks, 1510 and 1590, are connected to the router 1550 in a star configuration such that only a single router 1550 is used. A star configuration, or star topology as it may alternatively be called, uses a set of point to point links that radiate from a central location. The router 1550 is the central location in the MAN 1500 star configuration. Although only two sub-networks, 1510 and 1590, are shown in FIG. 15, any number of sub-networks can be connected to the router 1550.

The following network 1500 is described using references to OSI layers. However, communication over the network 1500 is not limited to communication protocols aligning with OSI layers. More generally, the systems and methods apply to networks implementing layered communication protocols.

The MAN 1500 shown in FIG. 15 includes a router 1550 having a plurality of ports. The router 1550 performs routing and packet forwarding functions using the network layer, or layer three, information embedded in data packets transmitted to a port on the router 1550. The router 1550 stores routing tables that allow it to determine to which port data packets are to be routed. For example, the router 1550 can be a CISCO 12000 series router, from Cisco Systems, Inc.

Alternatively, a controller, such as a Media Access Control (MAC) layer controller, can be connected to the router 1550. The controller can store the MAC layer addresses of various devices within the network and associate ports on the router 1550 with addresses. The router 1550 operates in conjunction with the controller to determine the correct port to which packets are to be routed.

For example, a client device 1521 can be associated with a first access point 1520a. The client device 1521 can request content from an IP address corresponding to a server, e.g. 1562. The MAC controller can store information that indicates the communication path from the client device 1521 to the router 1550. The client device 1521 communicates to the first access point 1520a. The first access point 1520a communicates with the second switch 1530 and the second switch communicates with the router 1550. Additionally, the MAC controller can store information that indicates the communication path from the router 1550 to the video server 1562. The router 1550 communicates with a first switch 1532, which communicates with the video server 1562.

Each port on the router 1550 is coupled to a device by a network branch. Three of the ports are coupled by network branches, 1554, 1556, and 1558 to switches 1532, 1530, and 1570 respectively. A fourth port is connected to an external network 1502. The external network 1502 can be a meshed network having a plurality of routers, and can be another sub-network, or the external network 1502 can be a Wide Area Network (WAN), such as the Internet. The MAN 1500 can be configured such that the network branch 1552 coupling the port on the router 1550 to the external network is intentionally bandwidth limited. The network branch 1552 operates as a bottleneck for data passing from and to the network 1500. For example, the network branch 1552 connecting the router 1550 to the external network 1502 can be a 10 Base TX or 100 Base TX communications link, or some other link having only limited data rate capabilities. A switch, such as the first switch 1532, is a multi-port device that selectively forwards packets from one of its ports to another. The switch's forwarding decision is based on layer two information. The switch 1532 does not modify a received packet. For example, the switch 1532 can be a CISCO 3500 series switch from Cisco Systems, Inc., such as a 3508 Ethernet switch.

One or more devices are connected to one or more of the other ports on the first switch 1532. Three servers, 1562, 1564, and 1566, are shown coupled to a port on the first switch 1532 that is different from the switch port that is connected to the router 1550. For example, each of the servers 1562, 1564, and 1566 can store video content or some other type of data or information. The servers 1562, 1564, and 1566 can be the video servers 170a-170c of FIG. 1. The server software can support one or more forms of video compression, such as Motion Picture Experts Group (MPEG) video compression, such as MPEG2 or MPEG4. A high quality video stream encoded using MPEG2 uses approximately six Mbits per second of data bandwidth. In one embodiment, the connection from the server 1566 to the first switch 1532 is a 100 Base FX fiber connection capable of supporting 1000 Mbit/s. The server is then limited to providing 166 video streams encoded using MPEG2 video compression. For example, each of the servers 1562, 1564, and 1566 can be an Apple Xserve™ computer running streaming server software such as Quicktime™. Each server can then be able to support sixty video streams.

The second switch 1530 has a first port connected to a port on the router 1550. A second port on the second switch 1530 is connected to a plurality of servers. The plurality of servers can include an IP/TV control server 1542, an IP/TV content server 1544, an IP/TV broadcast server 1546, and a Dynamic Host Configuration Protocol (DHCP)/Domain Name System (DNS) server 1548. A third port on the second switch 1530 is connected to a number of access points 1520a-1520c. A link is used to connect each access point 1520a-1520c to the port on the second switch 1530.

The access points 1520a-1520c provide wireless interfaces from the network 1500 to client devices, for example a client device 1521 near the first access point 1520a. The client devices do not form a part of the network 1500, but are able to connect to and communicate over the network 1500 using, for example, a wireless link to an access point 1520a-1520c.

Servers that perform administration, such as the IP/TV control server 1542, or the DHCP/DNS server 1548 typically do not require high data rate connections to the network. Thus, the connection from the servers 1542 and 1548 can be lower rate connections such as a 100 Base TX link.

The IP/TV servers 1542, 1544, and 1546 can be configured to broadcast multicast video streams to client devices connected to the network 1500. The third switch 1570 operates in a second sub-network 1590. A first port on the third switch 1570 is connected to a port on the router 1550. A second port on the third switch 1570 is connected to three access points 1580a-1580c within the second sub-network 1590. A link connects each of the access points 1580a-1580c to the port on the third switch 1570. The three access points 1580a-1580c connected to the third switch 1570 provide wireless access to the second sub-network 1590 of the network 1500.

The MAN 1500 can be configured to support any type of data protocol. For example, the MAN 1500 can be an Ethernet network operating in accordance with IEEE 802.3. In alternative embodiments, the MAN 1500 can communicate using Asynchronous Transfer Mode (ATM), or some other communications protocol.

Any of the network branches, 1552, 1554, 1556, and 1558 can be implemented using wireline links or wireless links having sufficient bandwidth. The network branches 1554, 1556, and 1558 connecting ports on the router 1550 to switches 1532, 1530, and 1570 respectively, can be 100 Base FX multimode fiber links. The network branches 1554, 1556, and 1558 can, for example, be free space optical links. Similarly, any of the links from the switches 1530, 1532, and 1570 can be implemented using wireline links or wireless links of sufficient bandwidth. Examples of links include, but are not limited to, wired links, radio frequency links, and optical links, including fiber and free space optical links.

The first sub-network 1510 shows three of the connection points configured as access points 1520a-1520c adapted to operate as wireless connection points to the network 1500. For example, the access points, 1520a-1520c, can operate in accordance with IEEE 802.11. Furthermore, the access points 1520a-1520c can be configured to operate according to IEEE 802.11 a or IEEE 802.11 b, or some other wireless interface standard, and within each particular standard, the access points 1520a-1520c can be configured to operate in any of the frequency bands defined within the specifications. For example, an access point 1520a-1520c can be configured to operate in one or more of the frequency bands specified for the three regions defined in IEEE 802.11. Alternatively, proprietary protocols can be used and the wireless links can operate in one or more frequency bands in combination with, or exclusive of, wireless links that operate using one or more optical wavelengths.

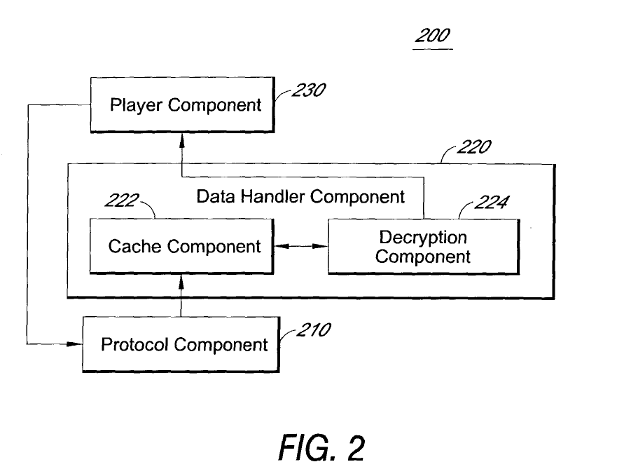

FIG. 2 is a functional block diagram of a client device 200. The client device 200 can, for example be one of the client devices 110a-110c operating in the content communication system 100 of FIG. 1 or the client device from FIG. 15.

The client device 200 includes a player component 230 that presents the content file to the user. The player component 230 can include the display, audio output device, and other output devices or means for presenting the content file to the user. Additionally, the player component 230 can include the user interface that provides user control over the content file. For example, the content file can be a video file or a movie having video and audio. The player component 230 can include a video decoder and audio decoder to decode encoded data retrieved from the content source, such as the content source 130 of FIG. 1. The decoded video and audio can then be synchronized within the player component 230 and presented to the user. The video can be presented using a video display that can be a LCD screen, a plasma display, a CRT display, and the like, or some other means for display. The audio can be presented using an audio output device such as speakers, headphones, and the like, or some other means for audio output. User controls can be provided in a user interface and can include knobs, buttons, keypad, and the like, or other means for input. The user controls can accept user input to control the presentation of the content file, such as to allow fast forwarding or rewinding of the movie.

A data handler component 220 is connected to the player component 230. The data handler component 220 includes a cache component 222 connected to a decryption component 224. The data handler component 220 is also connected to a protocol component 210.

The protocol component 210 retrieves the content file or other media data from the content source using a wireless communication link across the network. The protocol component 210 provides the functions relating to retrieving the content files from the network server. For example, the protocol component 210 supports the start, stop, and pause functions. Additionally, the protocol component 210 provides the hardware and software used to implement the communication protocol used in communicating over the network.

The protocol component 210 provides the retrieved data and content files to the data handler component 220. The data handler component 220 receives the data from the protocol component 210 and caches the data in the cache component 222.

The cache component 222 allows the data to be delivered at any rate, including rates that do not match the presentation rate of the data. For example, video content can be retrieved and stored in the cache component 222 at a rate greater than the presentation rate of the video. The network server can transmit the data in bursts or can transmit the data continuously. The cache component 222 ensures uninterrupted presentation of the data to the user.

Retrieved data that is stored in the cache component 222 is provided to the decryption component 224. The decryption component 224 decrypts the content file stored in the cache and provides the content file to the player component 230 for presentation. Some or all of the data can be encrypted.

A content file can be, for example, a movie. The movie file can be stored in the network servers as multiple encoded segments. Each of the multiple encoded segments can include a header that identifies the track, its length, and its relative position in the movie file. The multiple encoded segments can be encrypted prior to transmission across the network to the client device 200. Alternatively, the network server can store the movie as multiple encrypted segments. The encryption can be performed on only the header portion to minimize the processing overhead added by the decryption algorithm to the overall movie file delivery and presentation process. The encrypted header portion can include encrypted data fields that identify various characteristics of an encoded body portion corresponding to the header. The encrypted data fields in the header can, for example, identify the track of the encoded body, its length, its relative position in the media file, and its encoding type. Additionally, an encrypted data filed in the header can identify information regarding other segments in the media or content file. For example, a first encrypted header can include an encrypted data field that identifies the second segment, or other segment, of the content file. Thus, it is possible to encrypt only the first header and encode all other segments in the content file. The decrypted segments are then assembled in order as an encoded data file that can be provided to the player component 230 for decoding and presentation. The entire movie file does not need to be decrypted and ordered prior to delivery to the player component 230. The presentation of the movie file to the user appears continuous provided the client device 200 retrieves, decrypts, and appends the movie segments to the existing movie file prior to actual of presentation. Thus, movie segments can be retrieved, cached, decrypted, and decoded while other, previously received, movie segments are presented to the user.

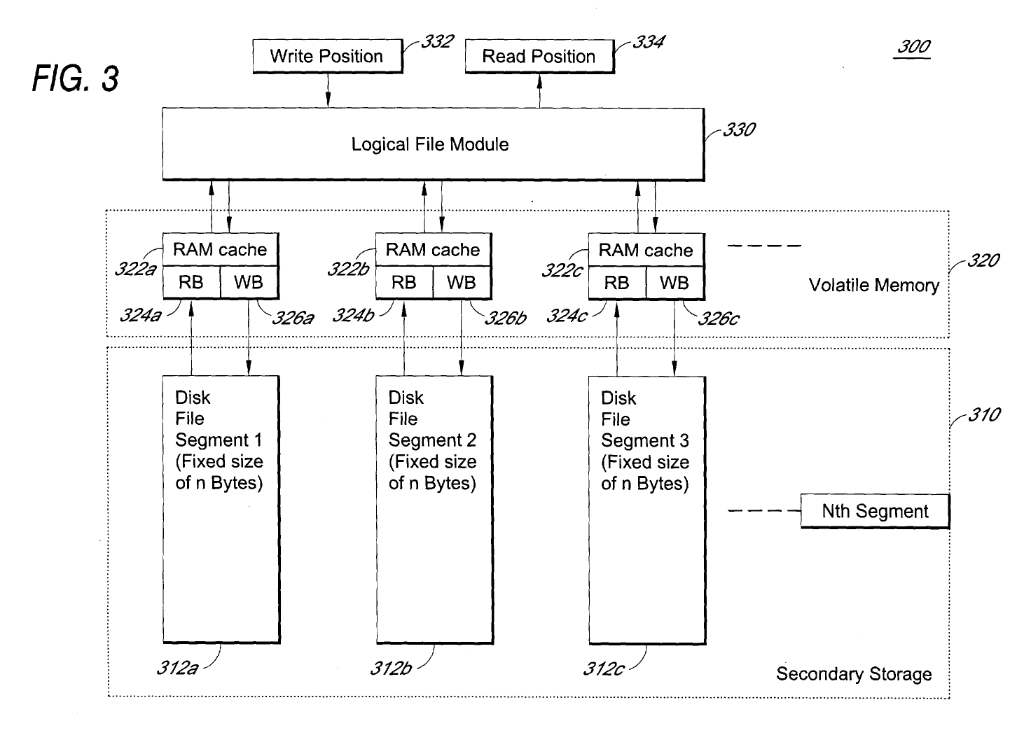

FIG. 3 provides a functional block diagram of a data handler component 300. The data handler component 300 can be, for example, the data handler component 220 of FIG. 2 and can be implemented in one of the client devices 110a-110c of FIG. 1. The data handler component 300 is configured to retrieve and store data at a rate that is faster than the presentation rate of the data. In contrast to real time media delivery where the content is delivered at an average data rate that is substantially equal to the presentation data rate, the data handler component 300 allows data delivery at a rate far exceeding the presentation rate for the data.

The data handler component 300 includes a logical file module 330 connected to a write position module 332 and a read position module 334. The logical file module 330 is also connected to the volatile memory 320. The volatile memory 320 is connected to the secondary storage 310. The data handler component 300 stores a portion of the retrieved data in volatile memory 320 and another portion of the retrieved data in secondary storage 310, such as in a hard disk. The use of volatile memory 320 to store a portion of the retrieved data minimizes the accesses to secondary storage 310.

The logical file module 330 organizes the multiple content file segments and presents the organized content file segments to the player component for decoding and presentation. The logical file module 330 includes the decryption component 224, discussed in FIG. 2, to decrypt the received segments and allow determination of the position of the segment in the content file. The logical file module 330 decrypts the received content file and writes the decrypted data to a location in memory. The logical file module 330 controls a write position module 332 to identify a memory location of the next data portion to be provided to the player component. The logical file module 330 also controls a read position module 334 that identifies a memory location for storage of the incoming data from the network. The logical file module 330 independently controls the write position module 332 and the read position module 334 to allow data to be written into the cache independently of data reads from the cache.

The write position module 332 can be a pointer, magnetic head, or other means for identifying a write position. Similarly, the read position module 334 can be a pointer, magnetic head, or other means for identifying a read position.

The volatile memory 320 includes multiple RAM cache modules 322a-322c connected to the logical file module 330. Each of the RAM cache modules 322a-322c includes a corresponding read buffer 324a-324c and a corresponding write buffer 326a-326c. The read buffers 324a-324c and the write buffers 326a-326c can each be implemented as one or more integrated circuits using in-memory data structures, such as linked lists or linear arrays.

The RAM cache module, for example 322a, maintains the read and write buffers, 324a and 326a, in synchronization with the read and write operation being performed. The RAM cache 322a receives the data from the logical file module and writes the data into the write buffer 326a. The RAM cache 322a performs a disk write, wherein the contents of the write buffer 326a are written to secondary storage 310, when the write buffer 324a is full. The RAM cache 322a can perform intelligent resize and look ahead read on the read buffer 324a after taking an average of the read requests that are presented to it by the logical file module 330.

For example, the content file can be a movie file with video and audio tracks that are divided into audio and video atoms. The player component can retrieve one video and audio atom at a time. An atom refers to a logical group of bytes. The number of bytes in the atom is dependent on the compression algorithm used for the data. A video atom can refer to the group of bytes representing a picture in a group of pictures. Similarly, an audio atom can refer to the number of bytes representing audio of a predetermined duration.

The secondary storage 310 includes one or more disk file segments 312a-312c that can be implemented in one or more storage devices, such as hard disk, RAID, integrated circuit memory, or other means for storage. The disk file segments 312a-312c can be dynamically sized and can be sized to store a single segment of a content file. The size of the disk file segment 312a can be dependent upon the content file encoding bit rate and operating system imposed file size limits. The disk file segments are erased and made available for additional content file segments when the stored segment is no longer required. For example, the client can be configured to allow a content file to be rewound during playback but can limit the rewind time to a predetermined rewind time, such as corresponding to five minutes presentation time. Additionally, the client can allow the content file to be fast forwarded up to a predetermined fast forward times, such as corresponding to thirty minutes of presentation time. A disk file segment 312a that is outside an accessible window of data, such as disk file segments that require greater than five minutes of rewinding, can be considered obsolete and can be deleted or erased and reallocated. The erasure and reallocation of disk file segments 312a-312c can occur during the presentation of a content file, such as during movie playback.

The content file is made secure against unauthorized access by the encryption and segmentation of the content files. Additionally, the network can be a secure private network and the client can be a closed device that does not allow a user all the features of a general-purpose device. These additional features can further ensure security of the content files.

The content file can include one or more segments and each segment can be encrypted. The logical file module 330 performs decryption and stores the content file segments into disk file segments 312a-312c in the secondary storage 310. The segments do not need to be transmitted in the same order as they are to be presented to the user. Furthermore, the logical file module 330 does not need to store the segments in any order within secondary storage 310, but can store the segments in any location and in any order. The logical file module 330 just needs to be able to identify the order of the segments and present the segments in order to the player component in order for the player component to present an ordered content file.

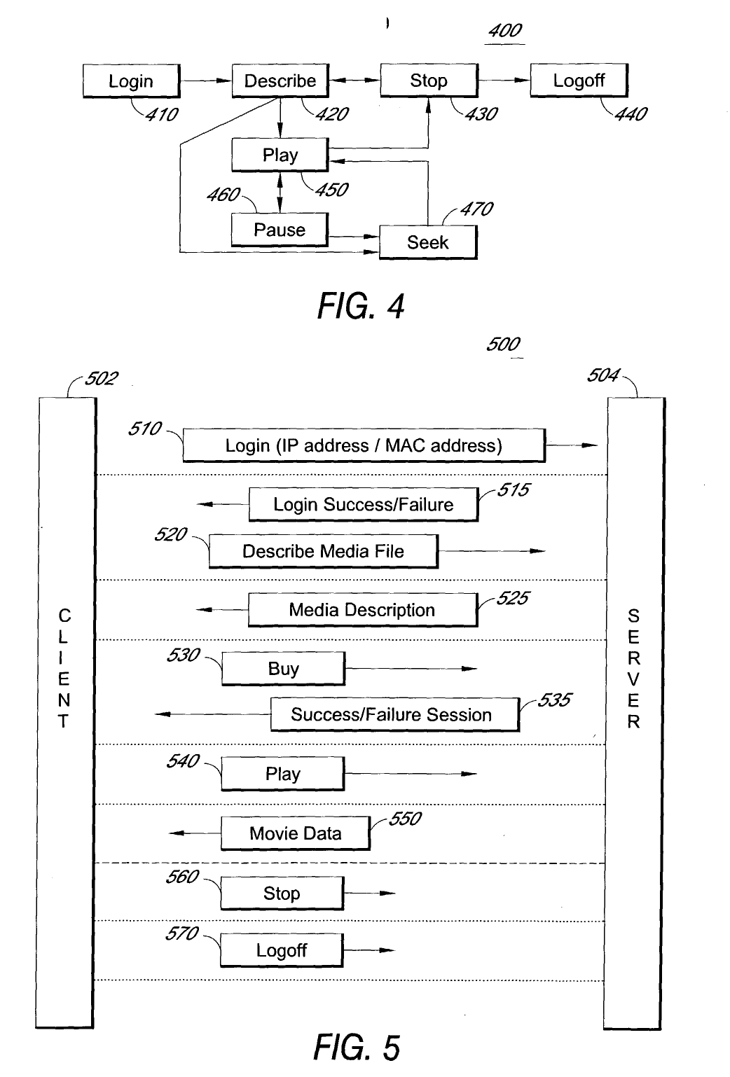

FIG. 4 is a state diagram 400 of a client device and the states which are supported by the player component and the protocol component. The client device can be one of the client devices 110a-110c of FIG. 1. The protocol component exchanges data with the network servers over at least two communication channels. The communication channels include a data channel and a control channel. The control channel is used to issue requests, such as those relating to the functions described below. The control data exchanged between the client device and servers can be plain text ASCII or some other data encoding. The data channel is used to transfer the content file payload data. The content file payload data can be transferred over the data channel, for example, as encoded movie data or encoded video data encapsulated using a communication protocol. For example, a movie payload data can be transferred over the data channel as encoded movie data with a TCP/IP header.

The client device state diagram 400 includes a login state 410 where the client device is authenticated with the content source. For example, in the system 100 of FIG. 1, the protocol component within the client device 110a communicates over the network 120 to the authentication server 140 within the content source 130 to authenticate and log in to the content source.

The client device can then proceed to a describe state 420 where the protocol component transmits a request for description of the media stored within the content source and retrieves a description of a particular media file stored within the content source. The description can include a general description of the contents of the media file and can include additional information regarding the properties of the media file. The properties of the media file can include the file size, the encoding rate, the number of file segments that the media file is divided into, the segment names, and other properties.

The client device can progress to a play state 450 in the state diagram 400. In the play state 450 the protocol component requests a media or content file from the content source. The media file can be delivered as a media stream from the network servers. The client device, via the protocol component, continues to retrieve the media file in the play state 450 until the entire media file is retrieved or until the client device is directed to another state.

The client device can also progress to the stop state 430 from either the describe state 420 or the play state 450. In the stop state 430 the protocol component sends an end command to end the retrieval of any media files from the servers. From the stop state 430 the client device progresses to the logoff state 440 where the client device disconnects from the server. Alternatively, the client device can return to the describe state 420 from the stop state 430.

The client device can also progress from the play state 450 to a pause state 460 where the protocol component transmits a pause command to the content source to pause retrieval of the media file until later resumption. For example, the client device can be configured to provide multiple functions or can retrieve multiple media files simultaneously. The user can, for example, direct the client device to pause retrieval of a particular media file to enable faster download of a second media file or to allow greater network bandwidth for an alternative function. The client device can also automatically transition from the play state 450 to the pause state 460 under severe network interruptions where no content can be downloaded.

The client device can progress from either the describe state 420 or the pause state 460 to the seek state 470. The seek state 470 allows the client device to perform a random seek on the media file segment on the network server. In the seek state 470 the user is allowed to quickly preview material in the content file, analogous to fast forward or rewind functions in other devices. The player component controls the protocol component based on user inputs to perform this function. The user can, for example, request the content file presentation be paused, fast forwarded, or rewound. During fast forward, the player component can present only a fraction of the data from the content file. For example, if the content file is a movie, the player component can skip some of the frames and present every other video frame or every third video frame to enable a fast forward or seek function. From the seek state 470 or the pause state 460 the client device can return to the play state 450 to resume retrieval of the media file.

FIG. 5 is a signal flow diagram 500 of communications between a client device 502 and a server 504 in the content communication system for a single media file download. The content communication system can be the content communication system 100 of FIG. 1. The client device can be one of the client devices, for example 110a, and the server can be the content source 130 of FIG. 1. The communication between the client device 502 and the server 504 occurs over a wireless network, such as the network 120 of FIG. 1.

Initially, the client device 502 performs a login to the system by transmitting a login request 510 to the server 504. The client device 502 can perform this function in the login state 410 of the state diagram of FIG. 4. The login request 510 can include an IP and a MAC address of the client device 502. The server 504 analyzes the login request 510 to determine if the client device 502 is permitted access to the system. The server 504 transmits a login success or failure message 515 to the client device 502 in response to the login message 510.

If the server 504 transmits a failure message 515 to the client device 502, the client device 502 is denied access to the system. The client device 502 can retry transmitting the login message 510 if the login failure is believed to be in error.

In response to a login success message 515, the client device 502 can access the server 504 and download content files. The client device 502 can proceed to the describe state 420 of FIG. 4. The client device 502 can transmit a describe media file request 520 in order to discover what media is available on the server 504. Alternatively, the describe media file request 520 can request a detailed description of a particular media file previously identified. In response to the describe media file request 520, the server 504 transmits a media description 525 to the client device. The media description 525 can, for example be a file that lists the media files that are stored in the server 504 and that are available for download.

The client device 502 can transmit a buy request 530 to the server 504 to initiate a purchase of a selected media file. The client device 502 can purchase a temporary copy of a content file from the server 504. The client device 502 can purchase a temporary copy in a manner analogous to a rental. In this manner, the client device 502 has access to content files on demand without the need or costs associated with purchasing a permanent copy. The server 504, in response to the buy request 530, will transmit a success message 535 including a session ID or a failure message 535 if there is an error.

The client device 502 can transmit a play request 540 to the server to initiate download and presentation of a particular media file. The client device 502 has transitioned to the play state 450 of FIG. 4. In response to the play request 540, the server 504 transmits movie data 550 or some other type of media file to the client device 502.

The client device 502 can transition from the play state 450 of FIG. 4 to the stop state 430. The client device 502 can transmit a stop message 560 to the server 504 to stop the data download process. The server 504 does not need to provide an affirmative response, but can stop data transfer in response to the stop message 560.

The client device 502 can then disconnect from the system by transmitting a logoff message 570 to the server 504. The server 504 can then update its data to indicate the end of the session.

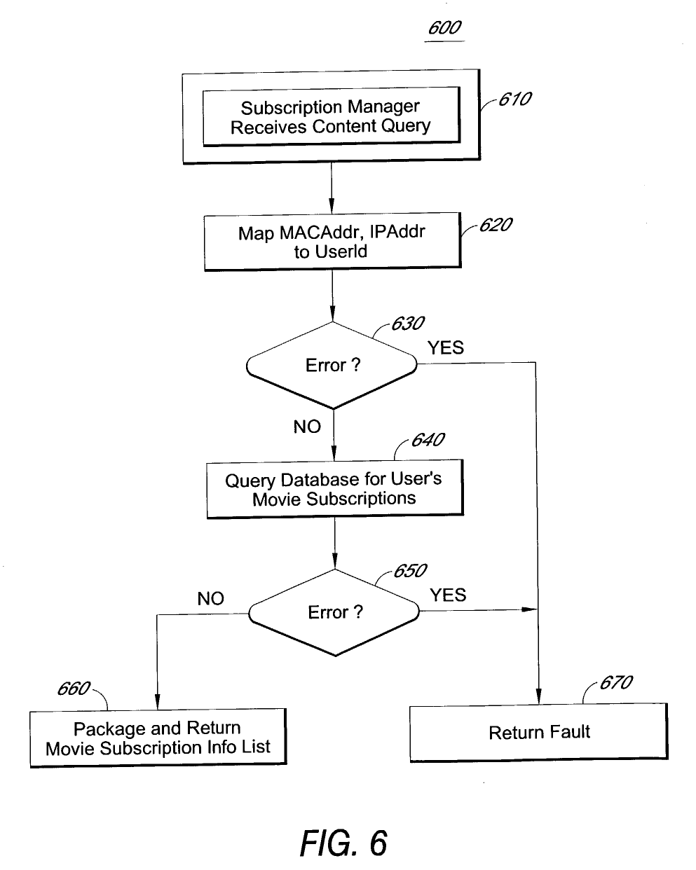

FIGS. 6 through 13 and FIG. 16 are flowcharts that detail the processes implemented by the server, such as the server 504 of FIG. 5 or the content source 130 of FIG. 1. In particular, the flowcharts detail the operation of the content billing server 160 of FIG. 1.

FIG. 6 is a flowchart of a process 600 performed by the subscription manager of FIG. 1 in response to receiving a content query. The process 600 begins when the subscription manager receives a content query 610 from a client, such as client device 110a in FIG. 1. The content query can for example be a request for a list of movies stored in the content server that are accessible by the client. The content query message transmitted by the client can include a MAC address and an IP address of the client.

The subscription manager proceeds to block 620 where the MAC address and IP address contained in the content query are mapped to a user identification (ID). The subscription manager can access the database for the MAC and IP addresses and locate a corresponding user ID. The subscription manager then proceeds to decision block 630 to determine if an error occurred while attempting to map the user ID. An error can occur, for example, if the IP address does not match a MAC address for the client device. Alternatively, an error can occur if the MAC address and IP address do not map to a user ID in the database.

If an error occurs, the subscription manager proceeds to block 670 where a fault message is generated and returned to the client device. The fault message can include a fault identifier and a displayable fault message. The fault identifier can provide a code to the client device corresponding to the type of error encountered by the subscription manager. The displayable fault message can be a text message or graphic message that is presented to the user of the client device to indicate a fault.

Returning to decision block 630, if no error occurs, the subscription manager proceeds to block 640 where the database is queried for the media files accessible to the client device. For example, the subscription manager can query the database for movies that are accessible to a particular subscription service set up by the user. A list of the media files can be generated.

The subscription manager then proceeds to decision block 650 to determine if an error occurred, such as if the query resulted in an error or if the subscription manager is unable to generate a query based on information corresponding to the user ID. If an error occurs, the subscription manager proceeds to block 670 to generate the fault message and transmit it to the client device. If no error occurs, the subscription manager proceeds to block 660 where the subscription manager packages and returns the media subscription information list to the client device. The media subscription information list can include media identifiers and corresponding displayable media names. The media identifiers can be used by the client device in subsequent media download requests.

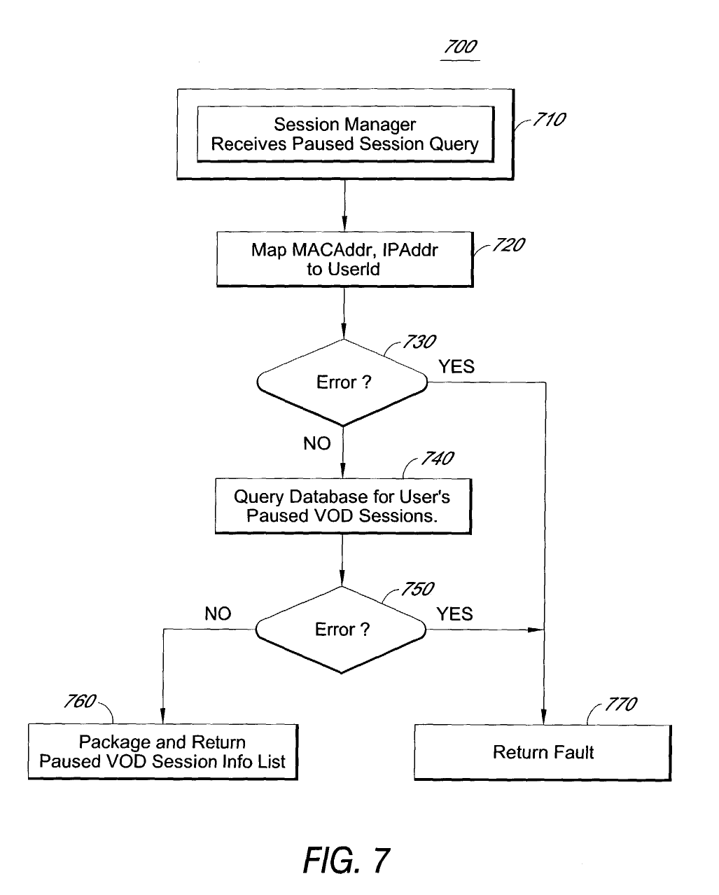

FIG. 7 is a flowchart of a process 700 performed by the session manager of FIG. 1 in response to receiving a request for paused sessions. As described in the state diagram of FIG. 4, a client device can pause a session and resume downloading and playing the media file at a later time. Because client device is able to initiate multiple sessions simultaneously, and can have one or more sessions paused, a client device can send a paused session query to the server to determine a list of paused sessions that can be resumed.

The process 700 begins when the session manager receives a paused session query 710 from a client device. The paused session query message transmitted by the client device can include a MAC address and an IP address of the client device.

The session manager proceeds to block 720 where the MAC address and IP address contained in the paused session query are mapped to a user ID. The session manager can access the database for the MAC and IP addresses and locate a corresponding user ID. The session manager then proceeds to decision block 730 to determine if an error occurred while attempting to map the user ID.

If an error occurs, the session manager proceeds to block 770 where a fault message is generated and returned to the client device. The fault message can include a fault identifier and a displayable fault message. Returning to decision block 730, if no error occurs, the session manager proceeds to block 740 where the database is queried for the active sessions that are paused by the client device.

The session manager then proceeds to decision block 750 to determine if an error occurred, such as if the query resulted in an error or if the session manager is unable to generate a query based on information corresponding to the user ID. If an error occurs, the session manager proceeds to block 770 to generate the fault message and transmit it to the client device. If no error occurs, the session manager proceeds to block 760 where the subscription manager packages and returns the paused session information list to the client device. For example, the session manager can return a list of paused Video-On-Demand sessions. Each item in the paused session information list includes a session identifier, which can be a session ID token, and a offset value that indicates an offset from a start of the media file where client device paused the file download.

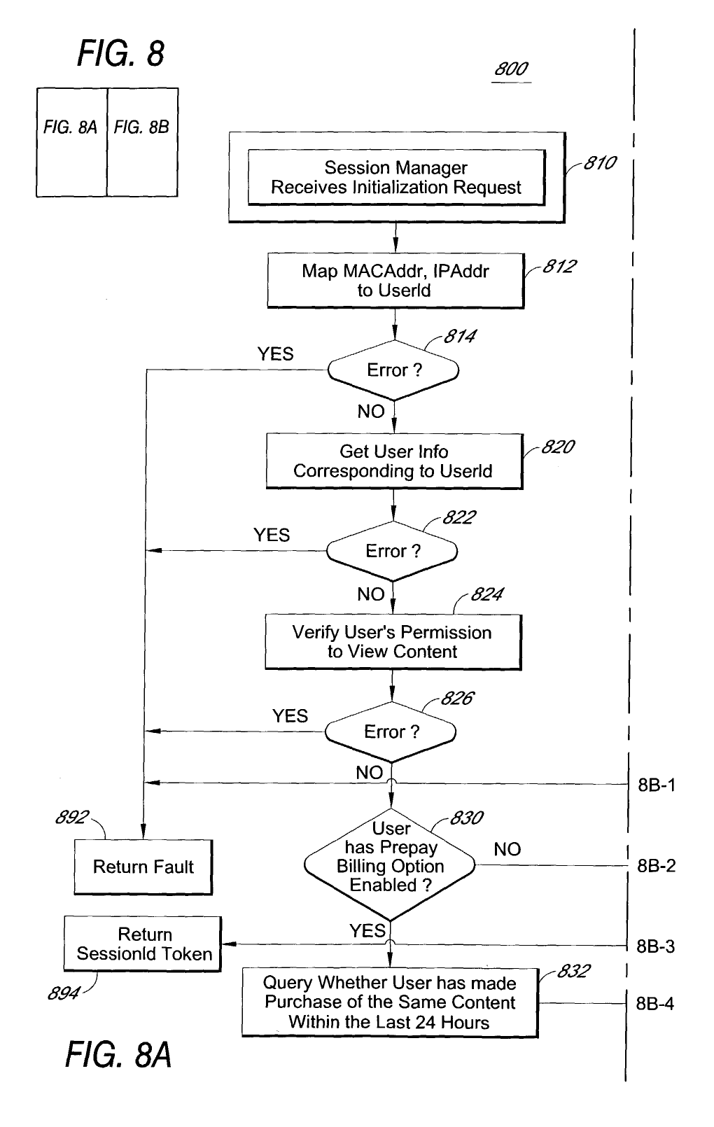

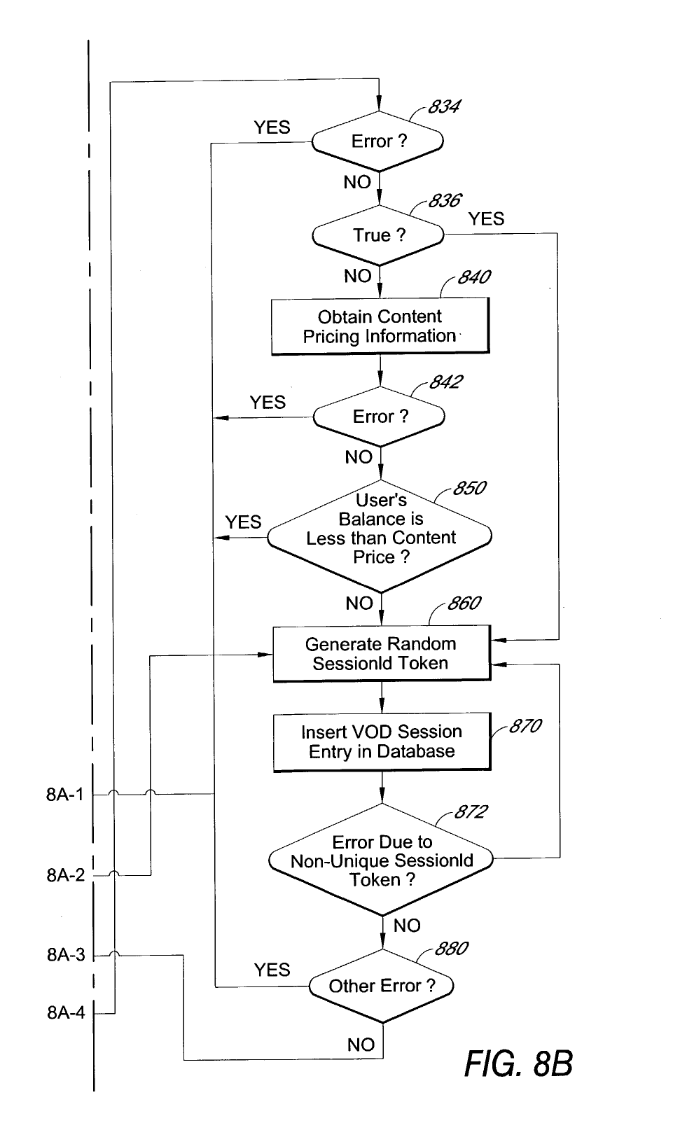

FIGS. 8A-8b are flowcharts of a process 800 performed by the session manager of FIG. 1 in response to an initialization request received from a client device. The client device sends an initialization request to the server to allow a particular media file to be made accessible for download. The process 800 begins when the session manager receives an initialization request 810 from the client device. The initialization request includes the MAC address and IP address of the client device and also includes a media identifier that indicates the media file to download. The media identifier can previously be received by the client device in response to a content query.

The session manager proceeds to block 812 where the MAC address and IP address are mapped to a user ID. The session manager can access the database for the MAC and IP addresses and locate a corresponding user ID. The session manager then proceeds to decision block 814 to determine if an error occurred while attempting to map the user ID.

If an error occurs, the session manager proceeds to block 892 where a fault message is generated and returned to the client device. The fault message can include a fault identifier and a displayable fault message. Returning to decision block 814, if no error occurs, the session manager proceeds to block 820 where the database is queried for the user information corresponding to the user ID. The database can include a user database that stores the user IDs and corresponding user information. As noted earlier, the database can store the MAC address and IP address corresponding to the user ID. The database can also store the user's payment option and account balance. The payment option can, for example, indicate whether the user's payment option is automatic payment, prepay, or some other payment option. The user's account balance indicates the amount owed by the user, and can be a positive or negative value, particularly if the prepayment option is chosen.

The session manager proceeds to decision block 822 to determine if the attempt to retrieve the user info resulted in an error. If an error occurred, the session manager proceeds to block 892 to generate and return a fault message to the client device. If no error occurred, the session manager proceeds from decision block 822 to decision block 824.

In block 824, the session manager retrieves from the database the user's subscription permissions, or media access permissions, corresponding to the media ID in the initialization request. The database stores information relating to the user's subscription permissions for viewing the content identified by the media ID. For example, a movie's ratings can determine if a particular movie can be purchased and viewed by the user.

The session manager then proceeds to decision block 826 to determine if verification resulted in an error. If an error occurred, the session manager proceeds to block 892 to generate and return a fault message to the client device. If no error occurred, the session manager proceeds from decision block 826 to block 830.

In decision block 830, the session manager examines the user information to determine if the user has chosen the prepayment billing option. If not, the session manager proceeds to block 860 in FIG. 8B discussed below. If, in decision block 830, the session manager determines that the user has chosen the prepayment option, the session manager proceeds to block 832.

In block 832 the session manager queries the database to determine if the user has made a purchase of the same content within the last 24 hours. The session manager does not need to perform this query for every media type. Additionally, the session manager can determine if the user purchased the same content for a predetermined period other than 24 hours. The session manager performs this check to allow the user to download and activate the same content as many times as the user desires within the 24 hour period from the initial purchase time stamp. Alternatively, the session manager can omit this check and the user can be billed for every content file requested. The session manager then proceeds to decision block 834 in FIG. 8B to determine if the query returned an error.

If an error occurred, the session manager proceeds to block 892 in FIG. 8A to generate and return a fault message to the client device. If no error occurred, the session manager proceeds from decision block 834 to decision block 836.

In decision block 836 the session manager determines if the query returned a “true” indicating the user has made a purchase within the last 24 hours. If a “true” indication is returned, the session manager proceeds to block 860 discussed below. If a “true” indication was not returned, the indication must be “false,” as an error indication has already been tested.

The session manager proceeds to block 840 to obtain the user's subscription rate from the user information. Alternatively, the session manager can obtain a media price or a content file price associated with the content and stored in the database. The session manager then proceeds to decision block 842 to determine if an error occurred. If an error occurred, the session manager proceeds to block 892 in FIG. 8A to generate and return a fault message to the client device. If no error occurred, the session manager proceeds from decision block 842 to decision block 850.

In decision block 850, the session manager checks to see if the user's balance is less than the subscription usage rate. This check is used to determine if the user has sufficient balance in the prepayment account to pay for the requested media file.

If the balance is insufficient, the session manager proceeds to block 892 in FIG. 8A to generate and return a fault message to the client device. If no error occurred, the session manager proceeds to block 860 to generate a random session ID token. The session manager can also advance to this block from decision blocks 830 or 836. The session ID token is used as the session identifier for the media file download.

From block 860, the session manager proceeds to block 870 where the session manager updates the database with the session entry data. The session entry data can include the session ID token, the service subscription ID, the state of the session, the time the session was initiated, the time the session was aborted, a reason the session was aborted, a time the session was started, a time the session was paused, an offset from the start time that the pause occurred, a time the session was ended, and a reason the session was ended. The session manager can update the session ID token, service subscription ID, initialization time, and state values in the session entry data. The state of the session can be updated to “pending.”

The session manager then proceeds to decision block 872 to determine if a non-unique session ID was generated in the random generator of block 860. If the session ID token is not unique, the session manager returns to block 860 to generate another session ID token. If the session ID token is unique, the session manager proceeds to decision block 880 to determine if any other errors were generated.

If an error occurred, the session manager proceeds to block 892 in FIG. 8A to generate and return a fault message to the client device. If no error occurred, the session manager proceeds to block 894 where the session ID token is transmitted to the client device.

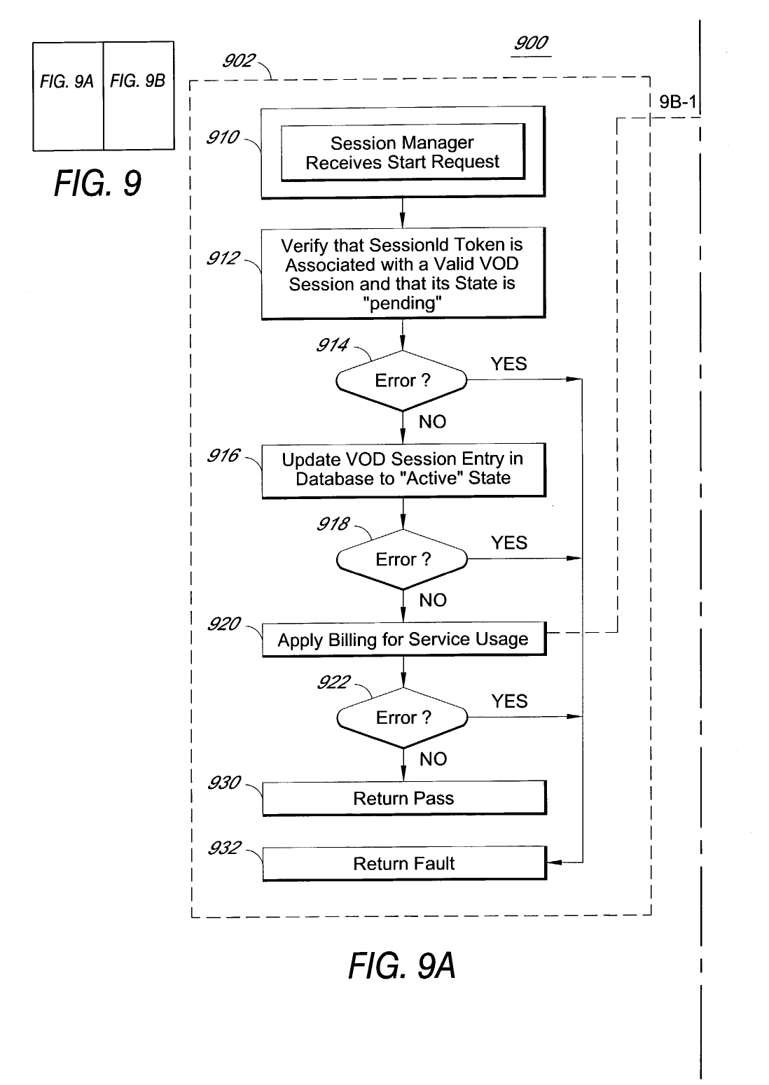

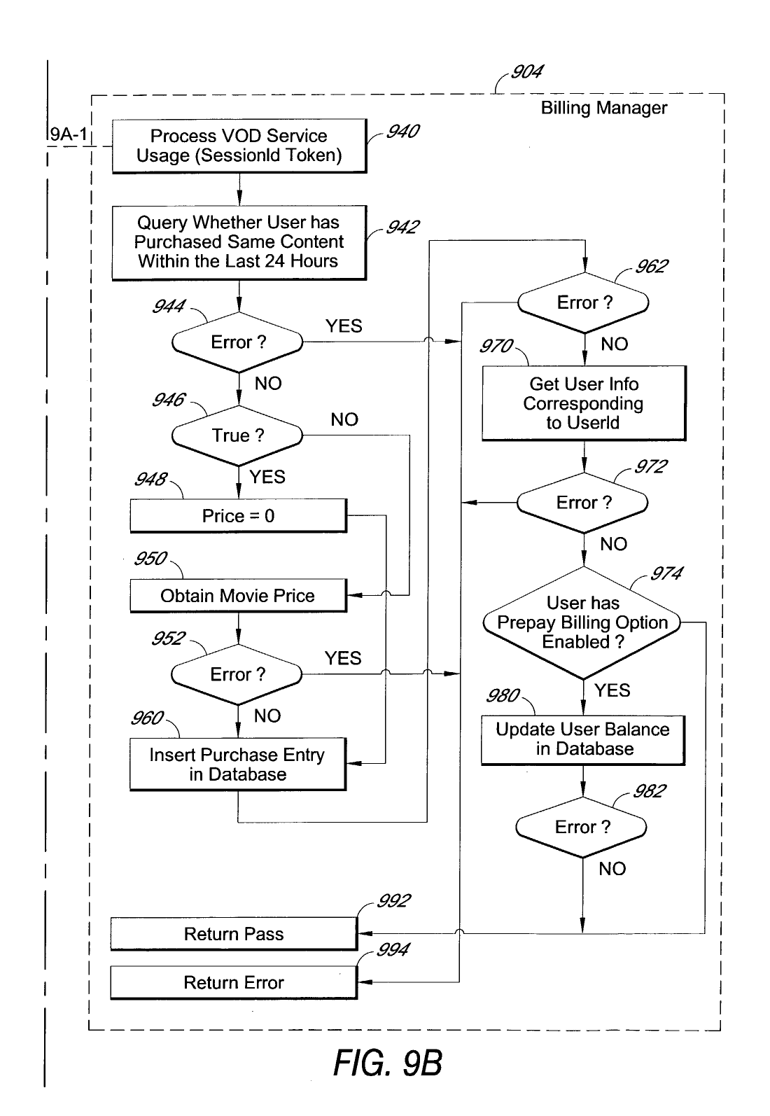

The client device can start downloading the media file after successful initialization of the session. FIGS. 9A-9B are flowcharts of a process 900 performed by the session manager and billing manager in response to a start request message transmitted by the client device. The process includes two sub-processes. A first sub-process 902 performed by the session manager allows the media download to begin. A second sub-process 904 performed by the billing manager determines and applies the bill to the user account.

The process 900 begins with the first sub-process 902 when the session manager receives a start request message 910 from the client device. The start request message includes the session ID token used to identify the session.

After the session manager receives the start request message 910, the session manager proceeds to block 912 where the session manager verifies that the session ID token is associated with a valid session. The session manager also checks to see that the current state of the session is “pending.” The session manager performs this check by accessing the database where the session data is stored.

The session manager next proceeds to decision block 914 to determine if the verification produced any errors. An error can occur, for example, if the session ID token provided is no longer valid or if the session is currently active, rather than pending. If an error occurs, the session manager proceeds to block 932 where a fault message is generated and returned to the client device. The fault message can contain a fault identifier and an error message that can be displayed at the client device.

Returning to block 914, if the session manager determines the verification does not produce errors, the session manager proceeds to block 916. In block 916, the session manager updates the previously stored session entries in the database. The session manager typically updates the state to “active” and stores a start time. The other data entries typically are not modified at this time.

After updating the session entries in the database, the session manager proceeds to decision block 918 where the session manager checks to see if the update process produced any errors. An error can occur, for example, if the session manager is unable to access the database entries. If an error occurs, the session manager proceeds to block 932 where a fault message is generated and returned to the source client device. If no error occurs, the session manger proceeds to block 920.

In block 920, the session manager applies billing for the service usage. The session manager transmits a process service usage message to the billing manager which results in execution of the second sub-process 904 by the billing manager as discussed below. From block 920 the session manager proceeds to decision block 922 to check for any errors.

If an error occurred, the session manager proceeds to block 932 to generate and return a fault message to the client device. If no error occurred, the session manager proceeds to block 930, and generates and returns a pass message to the source client device. The pass message acknowledges the start message sent by the client device was successfully processed. The servers are then configured to encrypt the desired media file for delivery to the client.

FIG. 9B is a flowchart of the second sub-process 904 executed by the billing manager. The second sub-process 904 begins at block 940 when the billing manager receives the process service request message 940 generated by the session manager in block 920 of FIG. 9A.

The billing manager proceeds to block 942 to query whether the user has made a purchase from subscription associated with the same session ID within the last 24 hours. The billing manager next proceeds to decision block 944 to determine if any error occurred.

If an error occurred, the billing manager proceeds to block 994 to generate and return a fault message to the session manager. If no error occurred, the billing manager proceeds to decision block 946 to see if the query run in block 942 returned a “true” value.

If a “true” is returned the billing manager proceeds to block 948 where the price of the current media access is set to zero. The billing manager then proceeds to block 960 discussed below.

Returning to decision block 946, if a “true” is not returned, the billing manager proceeds to block 950 to begin determining the cost associated with the current media access. In block 950, the billing manager accesses the database and retrieves the user's subscription usage rate for the media associated with the session ID token. The media can be, for example, a movie file. From block 950, the billing manager proceeds to decision block 952 to determine if any error occurred.

If an error occurred, the billing manager proceeds to block 994 to generate and return a fault message to the session manager. If no error occurred, the session manager proceeds to block 954 and sets the price equal to the subscription usage rate.

From block 954 and from block 948, the billing manager proceeds to block 960 to update the database entries. The purchase is entered into the database. The billing manager can write a purchase ID number, the service subscription ID number, the session ID token, and the price into the database.

The billing manager then proceeds to block 962 to check for errors. If an error occurred, the billing manager proceeds to block 994 to generate and return a fault message to the session manager. If no error occurred, the billing manager proceeds to block 970 to retrieve user information from the database.

In block 970, the billing manager retrieves the user information corresponding to the user ID from the database. The billing manager then proceeds to decision block 972 to check for errors. If an error occurred, the billing manager proceeds to block 994 to generate and return a fault message to the session manager. If no error occurred, the billing manager proceeds to decision block 974.

In decision block 974 the billing manager checks to see if the user has enabled the prepay billing option. If not, the billing manager proceeds to block 992 to return a pass to the session manager.

If prepay billing is enabled, the billing manager proceeds from decision block 974 to block 980 to update the user's balance. The current price for the media access is subtracted from the previous balance and stored as the new balance.

The billing manager then proceeds to decision block 982 to check for errors. If an error occurred, the billing manager proceeds to block 994 to generate and return a fault message to the session manager. If no error occurred, the billing manager proceeds to block 992 to return a pass to the session manager.

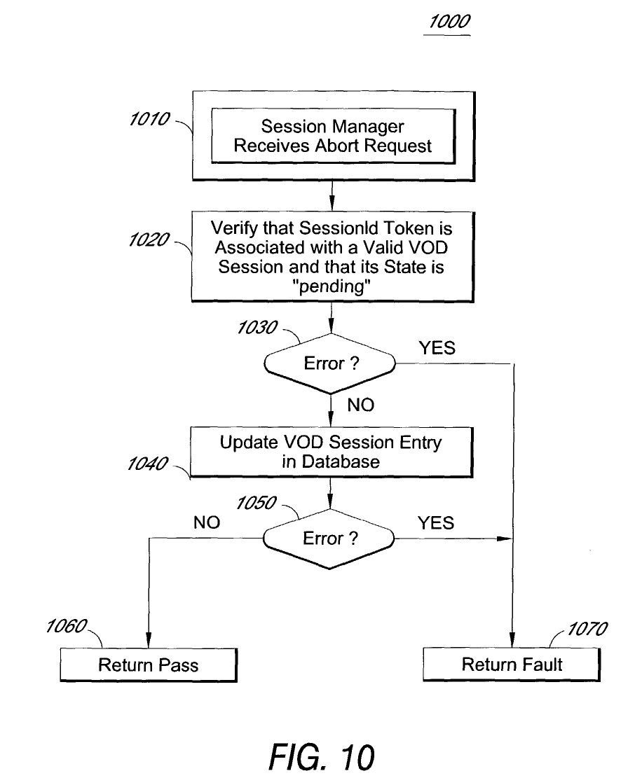

Instead of starting a download of a media file after initializing the session, the client device can direct the server to abort the session. FIG. 10 is a flowchart of a process 1000 performed by the session manager in response to an abort message sent by the client device. The abort message includes the session ID and a reason ID. The reason ID can be a predetermined code that corresponds to a reason for aborting the session. The reason can include, for example, a connection timeout or some other reason.

The process 1000 begins at block 1010 when the session manager receives the abort message from the client device. The session manager then proceeds to block 1020 to verify that the session ID is associated with a valid session and that the state of the session is “pending.” From block 1020 the session manager proceeds to decision block 1030 to determine if any errors occurred.

If an error occurred, the session manager proceeds to block 1070 to generate and return a fault message to the client device. If no error occurred, the session manager proceeds to block 1040 to update the database entries.

The session manager, in block 1040, updates the session entries in the database in response to the abort message. The state of the session is updated to indicate an aborted session. An abort time and the abort reason ID are stored in the database. The session manager then proceeds to decision block 1050 to determine if any errors occurred.

If an error occurred, the session manager proceeds to block 1070 to generate and return a fault message to the client device. If no error occurred, the session manager proceeds to block 1060 and returns a pass to the client device.

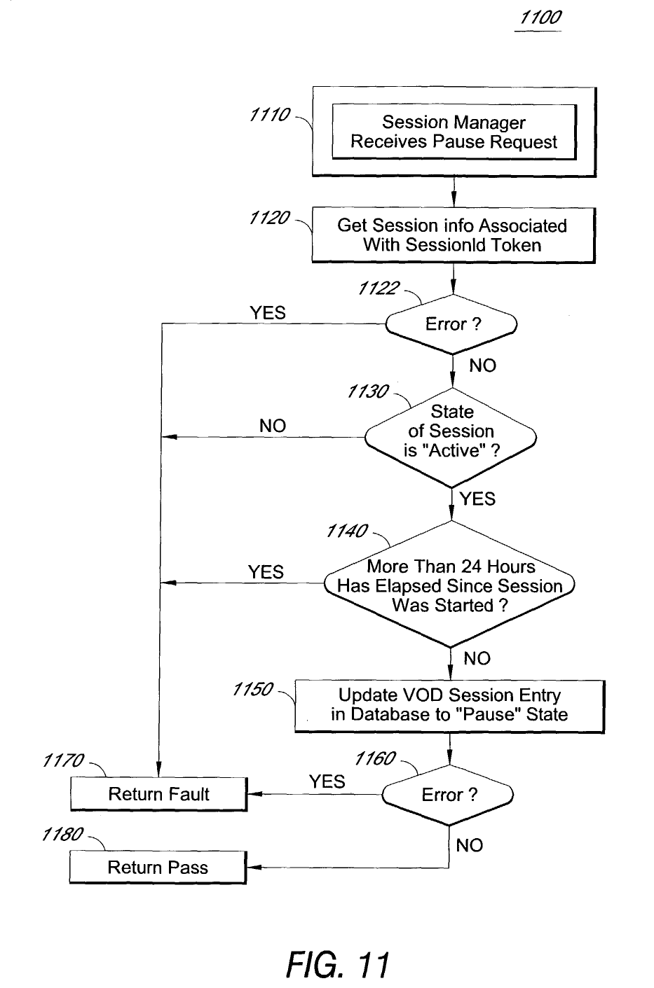

Once the client device has started a media download session, the client device can pause the download session and resume downloading later. FIG. 11 is a flowchart of a process 1100 that the session manager performs in response to receiving a pause message from the client device.

The process 1100 begins at block 1110 when the session manager receives a pause request from a client device. The pause request includes the session ID and an offset value that indicates an offset from the start where the media file download is paused. The session manager proceeds to block 1120 to retrieve the session information from the database. The session manager uses the session ID transmitted with the pause request to identify and retrieve associated information. The information can include the file name, the client device address, the status of the download, the status of the session, and other information.

The session manager proceeds to block 1122 to determine if any errors occurred. If an error occurred, the session manager proceeds to block 1170 to generate and return a fault message to the client device. If no error occurred, the session manager proceeds to decision block 1130 to determine if the state of the current session is “active.”

If the session is not active, the pause request was sent in error. The session manager proceeds to block 1170 to generate and return a fault message to the client device. However, if the session is active, the session manager proceeds to decision block 1140 to determine if more than a predetermined period of time has elapsed since the session was started. The predetermined period of time represents a period of time from the start of the session for which the session is valid. After the predetermined period of time has elapsed, the session is no longer valid and the client device can no longer access the media file. The predetermined period of time can be a period in which a user is expected to download and present a media file. The predetermined time can be, for example, 24 hours.

If more than 24 hours has elapsed since the session was started, the session is no longer valid. The session manager proceeds to block 1170 to generate and return a fault message to the client device. If the predetermined period has not yet elapsed, the session manager proceeds from decision block 1140 to block 1150 to update the database entries.

The session manager updates the state of the session to “paused.” The session manager also stores a pause time and an offset value to the database. The media servers can also be informed of the change in state to prevent further download during the paused state.

The session manager proceeds to block 1160 to determine if the update resulted in any errors. If an error occurred, the session manager proceeds to block 1170 to generate and return a fault message to the client device. If no error occurred, the session manager proceeds to block 1180 to generate and return a pass to the client device.

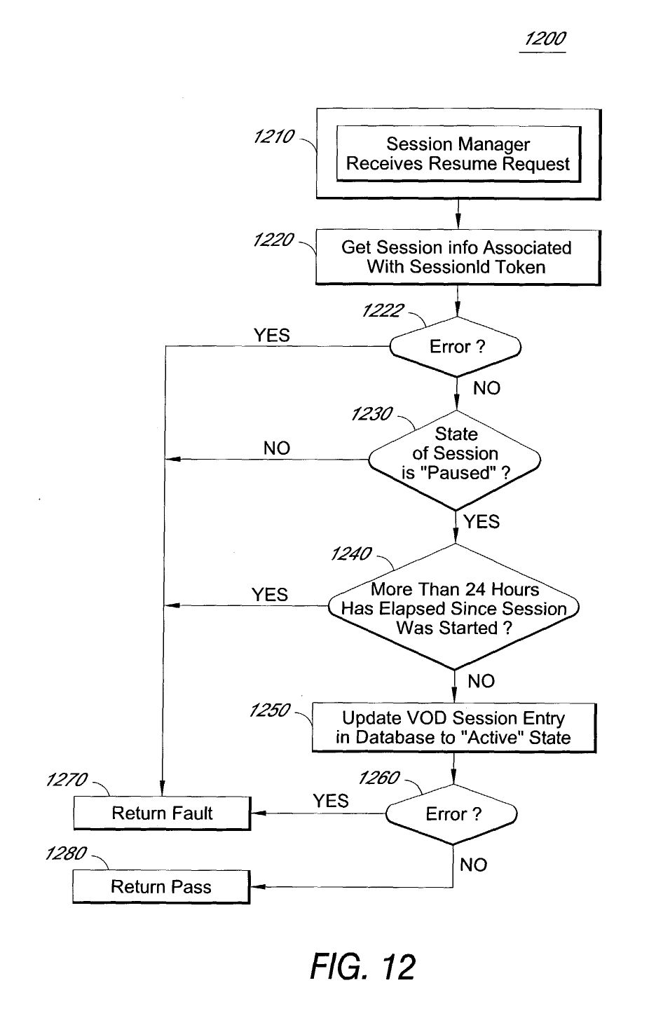

After pausing an active session, the client device can request to resume the session. FIG. 12 is a flowchart of a process 1200 performed by the session manager in response to a resume request.

The process 1200 begins at block 1210 when the session manager receives a resume request from a client device. The resume request includes the session ID. The session manager proceeds to block 1220 to retrieve the session information from the database. The session manager uses the session ID transmitted with the resume request to identify and retrieve associated information. The information can include the file name, the client device address, the status of the download, the status of the session, and other information.

The session manager proceeds to block 1222 to determine if any errors occurred. If an error occurred, the session manager proceeds to block 1270 to generate and return a fault message to the client device. If no error occurred, the session manager proceeds to decision block 1230 to determine if the state of the current session is “paused.”

If the session is not paused, the resume request was sent in error. The session manager proceeds to block 1270 to generate and return a fault message to the client device. However, if the session is paused, the session manager proceeds to decision block 1240 to determine if more than a predetermined period of time has elapsed since the session was started. The predetermined time can be the predetermined period for which a session is valid and can be, for example, 24 hours.

If more than 24 hours has elapsed since the session was started, the session is no longer valid. The session manager proceeds to block 1270 to generate and return a fault message to the client device. If the predetermined period has not yet elapsed, the session manager proceeds from decision block 1240 to block 1250 to update the database entries.

The session manager updates the state of the session to “active.” The media servers can also be informed of the change in state to allow the client device to resume download of the media file.

The session manager proceeds to block 1260 to determine if the update resulted in any errors. If an error occurred, the session manager proceeds to block 1270 to generate and return a fault message to the client device. If no error occurred, the session manager proceeds to block 1280 to generate and return a pass to the client device.

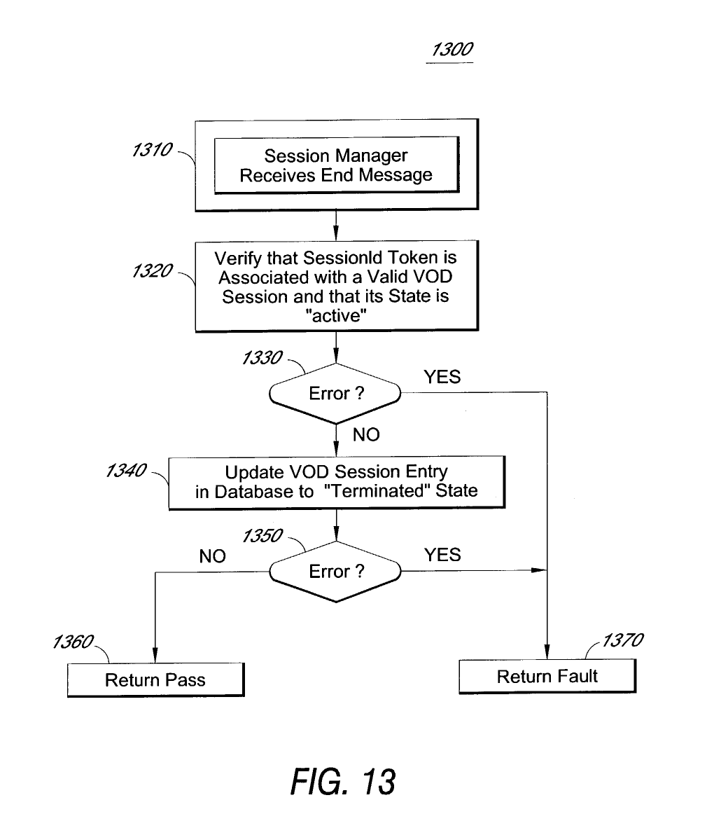

During download of a media file and after completely downloading a media file, the client device can send an end message to the server to terminate the session. FIG. 13 is a flowchart of a process 1300 performed by the session manager in response to receiving an end message from a client device.

The process 1300 begins at block 1310 when the session manager receives the end message from the client device. The end message includes the session ID and a reason ID for terminating the session. Possible reasons include, end of the media file, user initiated termination, server initiated termination, connection lost, or some other reason. The session manager then proceeds to block 1320 to verify that the session ID is associated with a valid session and that the state of the session is “active.” From block 1320 the session manager proceeds to decision block 1330 to determine if any errors occurred.

If an error occurred, the session manager proceeds to block 1370 to generate and return a fault message to the client device. If no error occurred, the session manager proceeds to block 1340 to update the database entries.

The session manager, in block 1340, updates the session entries in the database in response to the end message. The state of the session is updated to indicate a terminated session. An end time and the end reason ID are stored in the database. The session manager then proceeds to decision block 1350 to determine if any errors occurred.

If an error occurred, the session manager proceeds to block 1370 to generate and return a fault message to the client device. If no error occurred, the session manager proceeds to block 1360 and returns a pass to the client device.

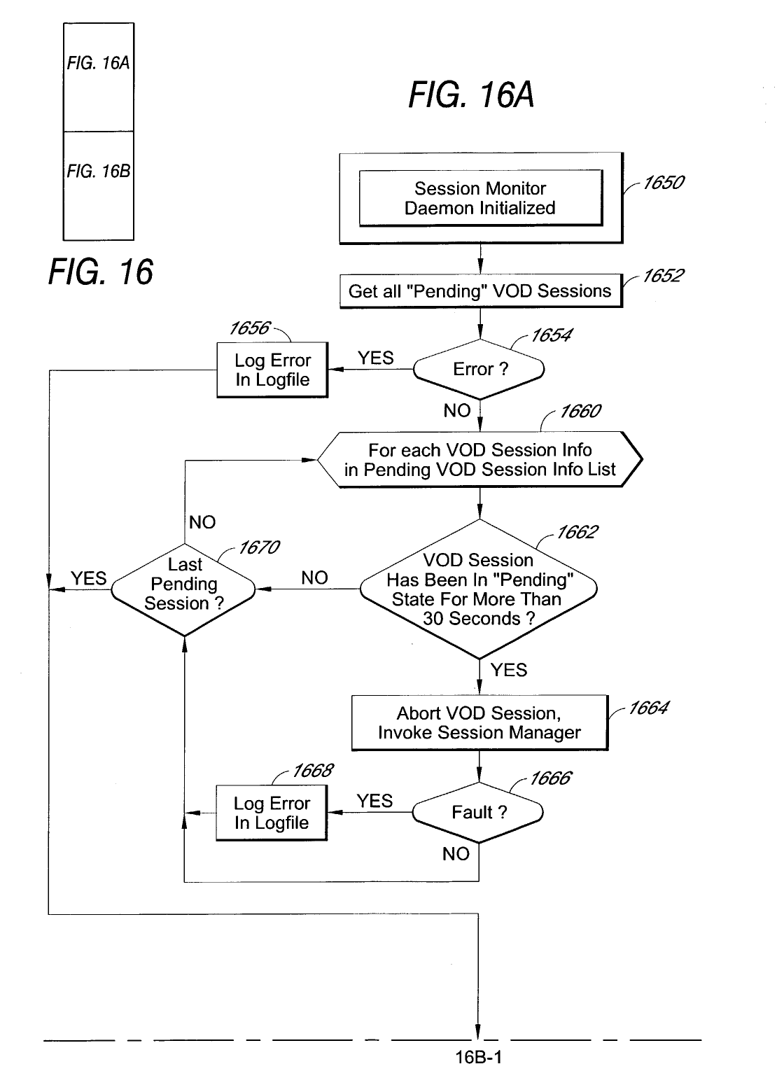

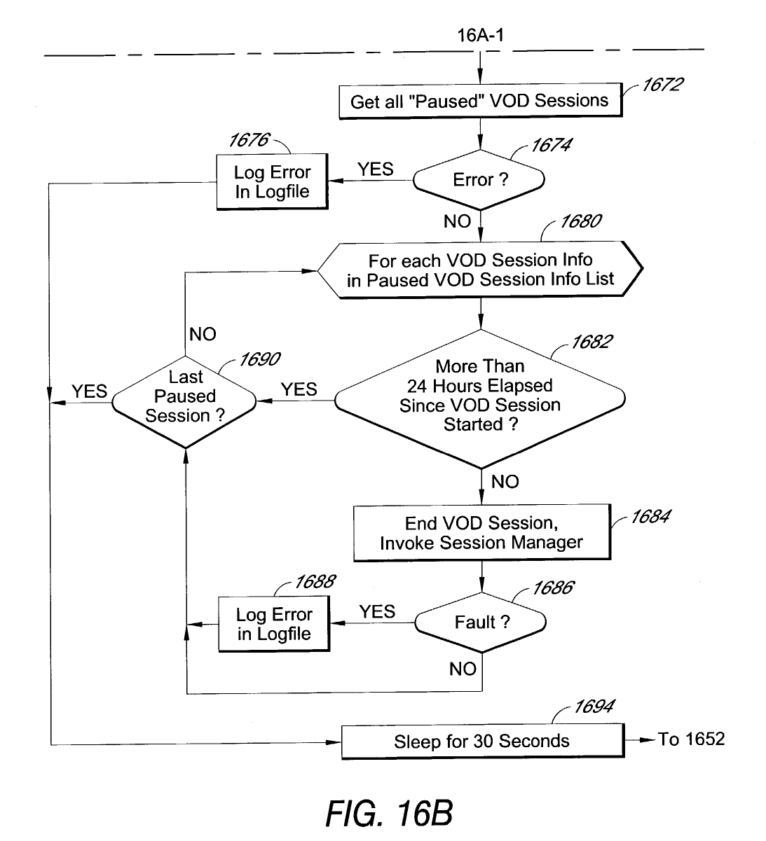

FIGS. 16A-16B are flowcharts of a process performed by the session monitor daemon 169 operating within the content billing server 160 of FIG. 1. The session monitor daemon 169 periodically monitors the health or status of each of the sessions initiated by the session manager.

The process begins at block 1650 when the session monitor daemon is initialized. The content billing server 160 can initialize the session monitor daemon 169 after the client device initiates a session with the content billing server 160. The process, in block 1652, begins by retrieving the session data entries for all pending sessions from the database. Here, the sessions are identified as Video-On-Demand (VOD) sessions, although the sessions can be sessions for any type of content. The session monitor daemon then proceeds to decision block 1654 to determine if the retrieval process resulted in any errors.

If in decision block 1654 the session monitor daemon determines that one or more errors occurred, the process proceeds to block 1656 where the session monitor daemon logs the errors in a logfile, which can also be stored in the database. After logging the errors, the session monitor daemon proceeds from block 1656 to block 1672 in FIG. 16B discussed below.

If in decision block 1654 the session monitor daemon determines that errors did not occur, the session monitor daemon proceeds to block 1660 where the process enters a loop to be performed for each group of VOD session data entries previously retrieved. The loop begins in decision block 1662 where the session monitor daemon determines whether the VOD session has remained in the pending state for more than a predetermined period of time, for example, 30 seconds.

If the session has not been pending for more than 30 seconds, the session monitor daemon proceeds to decision block 1670 to determine whether the session just analyzed was the last of the pending sessions retrieved from the database. If so the session monitor daemon exits from the loop and proceeds to block 1672 in FIG. 16B. If the retrieved session was not the last pending VOD session, the session monitor daemon returns to block 1660 to examine the data for the next pending session.

Returning to decision block 1662, if the session monitor daemon determines that the VOD session has been pending for more than 30 seconds, the session monitor daemon proceeds to block 1664 where an abort session request message is generated and communicated to the session manager. The session monitor daemon, in block 1664 waits to receive a pass or fault indication from the session manager.

The session monitor daemon next proceeds to decision block 1666 to determine if the session manager indicated a fault. If not, the session monitor daemon proceeds to decision block 1670 to determine if the data for the last pending session has been analyzed. If, in decision block 1666, a session manager fault is indicated, the session monitor daemon proceeds to block 1668 where the error corresponding to the session manager fault indication is stored in the logfile. From block 1668, the session monitor daemon proceeds to block 1670 to determine if the data for the last pending session has been analyzed.

Once all of the pending sessions have been examined, the session monitor daemon proceeds to block 1672, shown in FIG. 16B. In block 1672, the session monitor daemon retrieves, from the database, the session data entries for all of the paused VOD sessions. The session monitor daemon next proceeds to decision block 1674 to determine if the retrieval process resulted in an error.

If an error occurred, the session monitor daemon proceeds to block 1676 to log the error in the logfile. If no error occurred, the session monitor daemon proceeds to block 1680 where the process enters a loop to be performed for each group of VOD session data entries previously retrieved.

The session monitor daemon proceeds to decision block 1682 to determine if more than a predetermined period of time, for example 24 hours, has elapsed since the VOD session started. The session monitor daemon terminates those VOD sessions for which greater than the predetermined period of time has elapsed. Thus, if less than the predetermined period of time has elapsed, the session monitor daemon does not terminate the session and the session monitor daemon proceeds to block 1690 to determine if the data for the last paused session has been analyzed.

If, in decision block 1682, the session monitor daemon determines that greater than the predetermined period of time has elapsed since the start of the VOD session, the session monitor daemon proceeds to block 1684 where an end VOD session message is generated and communicated to the session manager. The session monitor daemon running the process then waits for the session manager response, which can be a pass or a fail acknowledgement message.

The session monitor daemon proceeds to decision block 1686 after receiving the acknowledgement message from the session manager. The session monitor daemon determines if the acknowledgement message indicates a pass or fail. If a pass is indicated, the session monitor daemon proceeds to decision block 1690 to determine if the data for the last paused VOD session has been analyzed. Alternatively, if a failure is indicated, the session monitor daemon proceeds to block 1688 to log the error in the logfile. The session monitor daemon then proceeds to decision block 1690 to determine if the data for the last paused VOD session has been analyzed.

In decision block 1690, the session monitor daemon determines if the data for the last paused VOD session has been analyzed. If not, the session monitor daemon remains in the loop and returns to block 1680 to examine the session data for the next VOD session. Alternatively, if the session data analyzed was the final session data, the session monitor daemon exits the loop and proceeds to block 1694 where the session monitor daemon sleeps, or waits, for a predetermined period of time before returning to block 1652 in FIG. 16A to resume analyzing the session data. The predetermined period of time can be, for example, 30 seconds to coincide with the time periods used in the determining if a pending session should be terminated. Thus, by returning to block 1652, the session monitor daemon periodically monitors the health of all pending and paused VOD sessions.

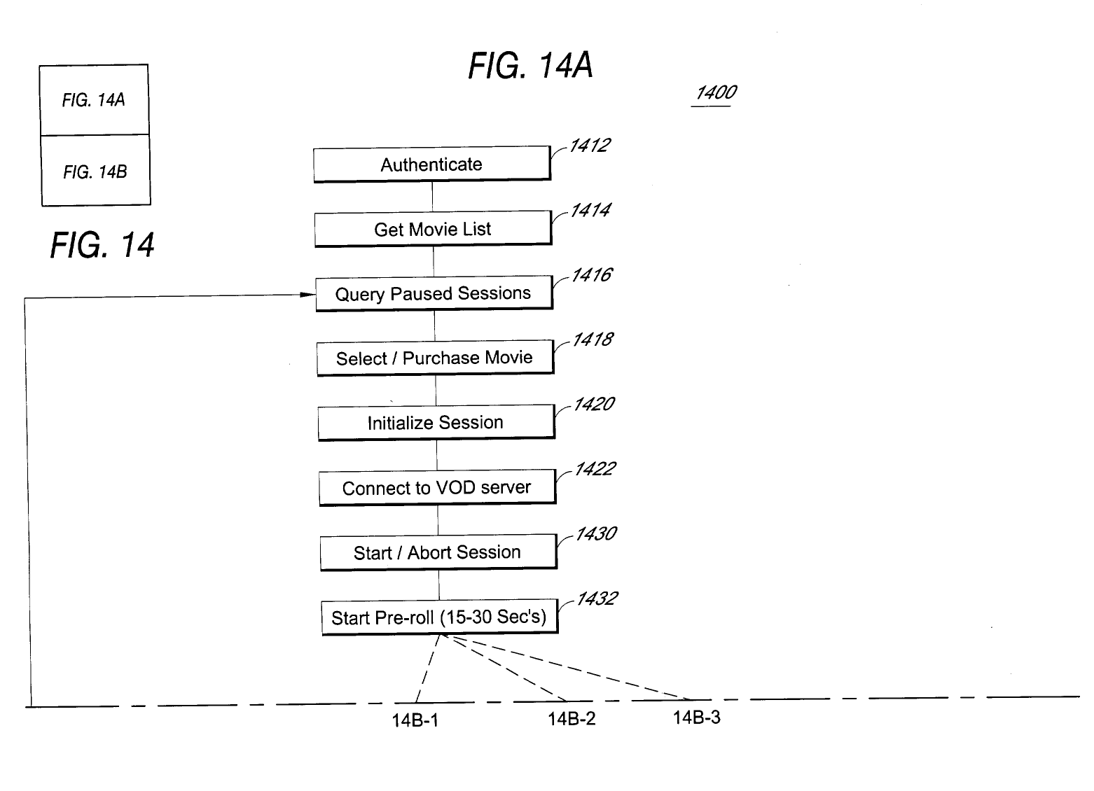

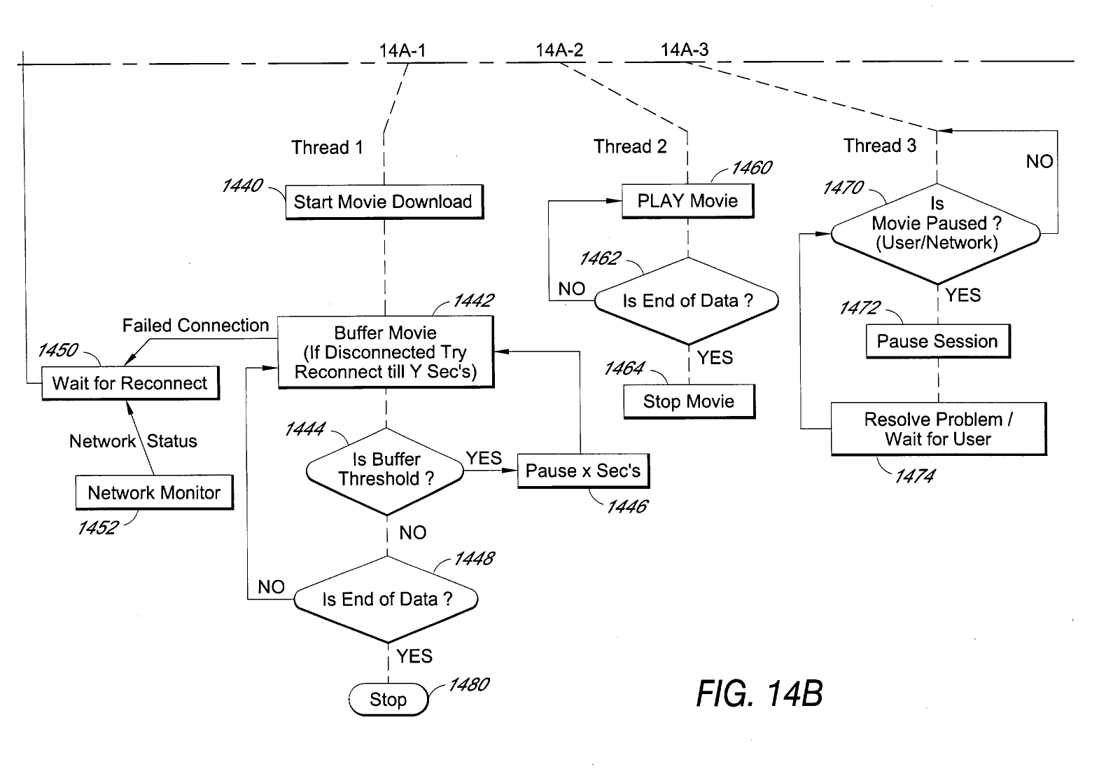

FIGS. 14A-14B are flowcharts of a process 1400 performed by the client device when engaged in a content communication system such as the system of FIG. 1. The process can be stored as a series of processor readable instructions within a storage device in the client device. A processor within the client device can then operate on the instructions to perform the process 1400 of FIGS. 14A-14B.

The process 1400 describes access and download of a movie file from available movie files stored in video servers at a content source. Of course, the media is not limited to movie files or video information.

The process 1412 begins at block 1412 where the client device authenticates itself to the system. The client device can present its IP and MAC addresses to an authentication server connected to the network. The client device is able to access the services provided by the system after authentication. The client device transmits the authentication message and receives a response from the server indicating successful authentication or no authentication. The client device cannot proceed if there is no authentication.

Provided the client device has authenticated with the system, the client device proceeds to block 1414 to retrieve a movie list from the server. The client device sends a query to the subscription manager. The query includes the IP and MAC addresses of the client device. The subscription manager uses this information to validate the subscription and to generate and transmit to the client device a list of movies available through the subscription. After the client device receives the movie list, the client device can proceed to block 1416 to query the server for any paused sessions. The client device may have paused a previously active session. Alternatively, the system can update the state of active sessions to “paused” for sessions that are active when the client device is disconnected from the network. The client device can have one or more paused sessions that remain in the paused state for a period of time even if the client device logs off the system. The client device can choose to resume a paused session or can initialize a new session.

The client device proceeds to block 1418 to select and purchase a movie to download and view. The client device sends a message with the paused session ID or can request a new session for a particular movie ID. The client device then proceeds to block 1420 to initialize a session where the movie file can be downloaded from the server.

After the session is initialized, the client device can connect to the video server in block 1422 in order to commence download of the movie. The client device then proceeds to block 1430 to start the session by sending a start message to the session manager. The client device can alternatively choose to abort the session by sending an abort message to the session manager.

Provided the client device chooses to start downloading the movie, the client device proceeds to block 1432 where a pre-roll time period elapses. The pre-roll time period is a predetermined period of time where the client device downloads the movie file from the server and begins to fill the buffer with the downloaded movie. The client device does not perform decoding and presentation of the media file during the pre-roll period. The pre-roll period is typically a short period of time and can be 5, 10 or 15 to 30 seconds in duration. The pre-roll period allows the player component a lead time such that the remainder of the movie can be downloaded while the movie is played. Because the network is configured to provide high bandwidth communications, the pre-roll period can be shortened over the period required in lower bandwidth systems.

After the pre-roll period has ended, the client device launches three different threads that can run simultaneously. The three threads include a download thread (thread 1 in FIG. 14B), a player thread (thread 2 in FIG. 14B), and an activity monitor thread (thread 3 in FIG. 14B).

The download thread, thread 1 in FIG. 14B, begins in block 1440. The client device starts to download the movie file. The client device connects with the appropriate video server and begins the download. The client device proceeds to block 1442 and continues to download the movie and stores the downloaded data in the cache component shown in FIG. 2. The client device continues to download and cache the movie data until the end of the movie is reached or another event interrupting download occurs, such as disconnection or buffer full.

The client device proceeds to decision block 1444 to determine if the buffer in the cache component is full. If so, the client device proceeds to block 1446 where the download waits for a predetermined period before returning to block 1442 to resume download. The client device waits for a predetermined period of time in block 1446 to allow the buffer to be emptied by the player component to free up space for the download process. The predetermined period can be a manner of minutes, seconds, or fractions of a second and can depend on the amount of data remaining to be downloaded and the download bandwidth. Additionally, the predetermined period can depend upon a time window over which the user may fast forward or reverse the content presentation plus a predetermined safety margin period. Because movie data is downloaded at a rate much faster than the presentation rate, the buffer will fill for any movie that requires more memory than is available in the cache component.

Returning to decision block 1448, if the buffer is not at the limit, the client device proceeds to decision block 1448 to determine if the end of the movie file has been reached. If so, the client device proceeds to block 1480 and the download thread is stopped. However, if the end of the movie file has not been reached, the client device returns to block 1442 to continue download.

Returning to block 1442, if the connection is lost during data download, the client device proceeds to block 1450 to wait for the connection to be re-established. A network monitor can be launched in block 1452 or can already be running in the background as part of a separate process. The client device initiates a reconnection attempt by waiting for a random time period and attempting reconnection. The client device can also attempt to contact the session manager and communicate a pause request message to pause the session. The client device waits for a reconnection indication from the network monitor prior to returning to block 1416 in FIG. 14A.

The player thread, thread 2 of FIG. 14B, begins at block 1460 when the client device initiates the start of the presentation and after the end of the pre-roll period. The client device proceeds to decision block 1462 to determine if the end of the data has been reached. If so, the client device proceeds to block 1464 and stops the playback. If the end of the data has not been reached, the client device returns to block 1460 to continue playing the movie.

The user activity monitor, thread 3 in FIG. 14B, listens to user or network requests to pause the active session or to perform data seek. The user activity monitor begins in decision block 1470 where the client device checks to see if a pause or seek command is issued. The client device continues to monitor for these commands during an active media download if they are not issued.

Once a pause or seek command is issued, the client device proceeds to block 1472 where the session is paused. The client device sends a pause request to the session manager and also communicates the pause to the player thread to pause the presentation of the data.

If a seek command is issued, the client device also pauses the player thread and seeks the movie file in the logical file of the data component according to the user commands. The client then proceeds to block 1474 to wait for the user to issue a resume command. The client device sends a resume command to the session manager and to the video server. The client device also communicates a resume command to the player thread to continue the presentation of the data. The client device then returns to decision block 1470 to monitor for pause or seek commands.

A content on demand system having one or more client devices communicating with one or more content servers has been disclosed. A client device can access media files from a content source using a wireless network connection. The media files are stored in servers in the content source as one or more segments of encoded content. The client device can download a file having more than one segment in any order and orders the segments in the client device prior to presentation. The video servers can encrypt a portion of the segment prior to providing it to the client device. The portion of the segment that is encrypted can be a header identifying the segment location, associated file, and length of the segment.

The client device buffers downloaded segments and re-orders the segments after decrypting the header to obtain the re-ordering data. The segments do not need to be physically ordered in memory but can be a logical file that is ordered using a data handler. The ordered segments can be decoded and presented to the user before all segments have been received.

Electrical connections, couplings, and connections have been described with respect to various devices or elements. The connections and couplings can be direct or indirect. A connection between a first and second device can be a direct connection or can be an indirect connection. An indirect connection can include interposed elements that can process the signals from the first device to the second device.

Those of skill in the art will understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present invention.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A method of receiving content on demand at a client device over a wireless communication link to a content source, the method comprising:
selecting a content file stored as a plurality of encoded segments in a remote content server;
transmitting over the wireless communication link, a request for the content file, the request including a MAC address and IP address of the client device;
receiving, over the wireless communication link, a portion of the content file, the portion received at a rate greater than a predefined presentation rate of a content represented by the portion;
decrypting the portion of the content file to produce a decrypted portion of the content file;
caching the decrypted portion of the content file; and
outputting to a user interface, at substantially the predefined presentation rate, the content represented by the portion.

2. The method of claim 1, wherein the content file comprises:
a first file segment; and
a second file segment.

3. The method of claim 2, wherein caching the portion of the content file comprises:
storing a first portion of the first file segment in a RAM; and
storing a second portion of the first file segment in a non-volatile memory.

4. The method of claim 3, wherein caching the portion of the content file further comprises:
storing a first portion of the second file segment in the RAM; and
storing a second portion of the second file segment in the non-volatile memory.

5. The method of claim 1, wherein the content file comprises a video file.

6. The method of claim 1, wherein the content file comprises:
a first file segment including a first encrypted header and a first encoded body; and
a second file segment including a second encrypted header and a second encoded body.

7. The method of claim 6, wherein the first encrypted header comprises an encrypted data field identifying the length of the first encoded body.

8. The method of claim 6, wherein the first encrypted header comprises an encrypted data field identifying a relative position of the first encoded body in the content file.

9. The method of claim 6, wherein the first encrypted header comprises an encrypted data field identifying an encoding type of the first encoded body.

10. The method of claim 6, wherein the first encrypted header comprises an encrypted data field identifying the second file segment and a network location of the second file segment.

11. A method of providing content on demand for use in a content source connected over a wireless network to one or more client devices, the method comprising:
storing a content file in a memory of the content source, the content file comprising a first segment and a second segment, the first segment including a first encrypted header and a first encoded body;
receiving a request over the wireless network for the content file from a first device;
transmitting to the first device, over a wireless link, at least a portion of the encoded first segment at a rate greater than a presentation rate of a content represented by the encoded first segment; and
adjusting a data rate of transmission of the second segment based at least in part on a number of active client device sessions and an available bandwidth.

12. The method of claim 11, further comprising monitoring a plurality of active sessions corresponding to a first client device.

13. The method of claim 11, further comprising monitoring a plurality of paused sessions corresponding to a first client device.

14. A method of receiving content on demand at a client device over a wireless communication link to a content source, the method comprising:
wirelessly transmitting a request for a video file to the content source
receiving, over the wireless communication link, the video file comprising a first video segment and a second video segment;
decrypting the first video segment to generate a first decrypted video segment;
decrypting the second video segment to generate a second decrypted video segment;
storing the decrypted first video segment in a first storage location;
storing the decrypted second video segment in a second storage location;
determining an order of the decrypted first video segment and the decrypted second video segment in the video file; and
presenting, at a predetermined presentation rate, the video file.

15. The method of claim 14, further comprising, prior to presenting the video file:
decoding the decrypted first video segment; and
decoding the decrypted second video segment.

16. The method of claim 14, further comprising wirelessly receiving a third video segment of the video file concurrent with presenting the video file.

17. The method of claim 14, further comprising, prior to receiving the video file:
wirelessly transmitting a MAC address and an IP address of the client device, over a data channel, to a content server; and
wirelessly transmitting a content query over the data channel to the content source requesting a list of media files.

18. The method of claim 14, wherein receiving, over the wireless communication link, the video file comprises:
wirelessly receiving, over a data channel, the first video segment comprising a first encrypted header and a first encoded video data; and
wirelessly receiving, over the data channel, the second video segment comprising a second encrypted header and a second encoded video data.

19. The method of claim 14, wherein decrypting the first video segment comprises decrypting a header portion of the first video segment to determine a relative position of the first video segment in the video file.

20. The method of claim 14, further comprising, prior to receiving the video file:
transmitting, over a control channel to the content source, an initialization message including a MAC address and an IP address of the client device and a media file identifier; and
receiving from the content source an acknowledgement message including a session ID.

21. The method of claim 14, further comprising wirelessly transmitting, over a control channel, a pause command to a content source to stop receiving the video file, the pause command including an offset value relative to a start of the video file.

22. The method of claim 21, further comprising wirelessly transmitting, over the control channel, a resume command to the content source, the resume command including a session ID.

23. A method of providing content on demand from a content source to a client device over a wireless communication link, the method comprising:
storing a media file as multiple encoded segments in the content source;
receiving, an initialization request over a control channel of the wireless communication link, the initialization request including a MAC address of the client and a media file identification;
generating a session ID in response to the initialization request;
wirelessly transmitting the session ID to the client;
receiving over the control channel of the wireless communication link, a start request including the session ID;
encrypting a header for each of the multiple encoded segments; and
transmitting over a wireless communication link, at a rate greater than a presentation rate of the media file, each of the multiple encoded segments having an encrypted header.

24. The method of claim 23, further comprising:
receiving a pause request over the control channel, the pause request including a session ID and an offset value;
storing the offset value;
terminating the transmission of the multiple encoded segments.

25. The method of claim 24, further comprising:
receiving a resume request over the control channel;
retrieving the offset value;
determining a paused segment from the multiple encoded segments based in part on the offset value; and
transmitting the paused segment and segments having a start position greater than the offset value over the wireless communication link.

26. The method of claim 23, further comprising:
determining a billing option;
determining a media access permission;
determining a bill for the media file based in part on a media price; and
applying the bill to a client device account based in part on the billing option.

27. The method of claim 23, further comprising monitoring a plurality of active sessions corresponding to a first client device.

28. The method of claim 23, further comprising monitoring a plurality of paused sessions corresponding to a first client device.

29. A method of providing content on demand, the method comprising:
storing multiple encoded media file segments in a first server;
storing copies of the multiple encoded media file segments in a second server;
selectively transmitting an encoded segment from the first server or a copy of the encoded segment from the second server based, at least in part, on a load on the first server.

30. A portable video display device configured to communicate over a wireless network with, and request media files from, a remote content source, the device comprising:
memory;
a data handler component configured to receive encrypted media file segments, decrypt the encrypted media file segments to produce encoded media file segments, determine a relative order of the encoded media file segments; and store the encoded media file segments in the memory; and
a player component configured to retrieve the encoded media file segments from memory, decode the media file segments and present the decoded media file segments at a predetermined presentation rate based in part on received user commands.

31. The device of claim 30, wherein the each of the encrypted media file segments comprises:
an encrypted header portion containing media file identification data and relative position data; and
an encoded media payload portion.

32. The device of claim 30, wherein the data handler component determines the relative order of the encoded media file segments based in part on data recovered from decrypting a header portion of each encrypted media file segment.

33. The device of claim 30, wherein the memory comprises:
volatile memory; and
non-volatile memory; and
wherein the data handler stores a first portion of each received decoded media file segment in volatile memory and a second portion of each media file segment in non-volatile memory.

34. The device of claim 30, wherein the data handler component deletes the encoded media file segment from memory a predetermined time after the player component has decoded and presented the decoded media file segment.

35. A portable video display device configured to communicate over a wireless network with, and request media files from, a remote content source, the device comprising:
means for storage;
means for accepting user input;
means for presenting a media file;
a data handler component configured to receive encrypted media file segments, decrypt the encrypted media file segments to produce encoded media file segments, determine a relative order of the encoded media file segments; and store the encoded media file segments in the means for storage; and
a player component connected to the means for storage and the means for presenting the media file and configured to retrieve the encoded media file segments from the means for storage, decode the media file segments and, based in part on user commands received by the means for accepting user input, output the decoded media file segments at a predetermined presentation rate using the means for presenting the media file.

36. A content on demand system for wireless delivery of content files to one or more client devices, the system comprising:
a client device configured to wirelessly transmit, over a control channel of a wireless communication link, a request for a content file and further configured to wirelessly receive the content file, decode the content file, and present the content file; and
a content source comprising:
a protocol module configured to receive the request for the content file, and parse the request;
a session manager in communication with the protocol module configured to receive the parsed request for the content file from the protocol module and further configured to initiate a session with the client device;
a first server configured to store a first encoded segment of the content file;
a second server configured to store a second encoded segment of the content file;
a buffer manager configured to retrieve the first encoded segment from the first server and the second encoded segment from the second server;
a bandwidth manager configured to access the buffer manager and transmit the first encoded segment and the second encoded segment to the client device; and
a load balance server configured to balance an access of the first and second encoded segments from the first and second servers.

37. The system of claim 36, wherein the content source further comprises a session monitor daemon configured to periodically monitor a status of each session initiated by the session manager.
